(19) United States
(12) Patent Application Publication
(10) Pub. No.: US 2010/0195279 A1
(43) Pub. Date: Aug. 5, 2010

(54) DOCKING STATION AND KIT FOR A PERSONAL ELECTRONIC DEVICE

(75) Inventor: Hennessy Michael, Dublin (IE)

Correspondence Address: JOHN F. LETCHFORD, ARCHER & GREINER, P.C., ONE CENENNIAL SQUARE, HADDONFIELD, NJ, 08033, US

(73) Assignee: BLUE BEE LIMITED, Tallaght, Dublin (IE)

(21) Appl. No.: 12/669,260

(22) PCT Filed: Jul. 18, 2008
(86) PCT No.: PCT/EP08/59481

§ 371 Date: Jan. 15, 2010

(30) Foreign Application Priority Data
Jul. 18, 2007 (EP) 07014064.5
May 13, 2008 (IE) S2008/0375

(51) Int. Cl. G06F 1/16

(52) U.S. Cl. 361/679.41

(57) ABSTRACT

The present invention relates to a docking station kit for a personal electronic device such as a mobile phone, the docking station kit comprising a docking support having defined therein a first compartment space in which the personal electronic device is dockable and a second compartment space in which a modular accessory for the personal electronic device is dockable. The docking station kit further comprises at least two modular accessories which are interchangeably dockable within the second compartment space. Further embodiments describe the docking support with an alternative number and/or alternative arrangements of compartments along with various alternative modular accessories that are interchangeably dockable within these compartments. The interchangeable modular accessories can be used to add additional functionality to the personal electronic device quite easily. Parts can be added and interchanged while the device otherwise functions as an integral unit when assembled.

### FIELD OF THE INVENTION

The present invention relates to a docking station and docking station kit for a personal electronic device, such as a phone. In particular, of interest are personal electronic devices such as mobile (cellular) phones.

### BACKGROUND TO THE INVENTION

The convergence of various technologies has meant that personal electronic devices have become multifunctional. For example, it is in usual to include music playing functionality and Internet connectivity to what were traditionally solely gaming consoles. An example is the PlayStation portable (PSP). On the other hand, mobile telephones have included increased functionality including Internet access for upload or download of software or music, imaging and other multimedia. Phones are supplied with electronic games and can download others. Many other devices such as MP3 players and PDA (Personal Digital Assistant) devices all include functionality, which extends beyond the primary functionality of the device. One of the common features of such devices is that they are all portable, that is designed to travel with the user. They are often sized to fit within a clothing pocket.

In order to ensure portability of devices, by reducing overall dimensions, the size of devices have been increasingly miniaturised. There is a conflict between reducing the size of the device and providing additional functionality. For example buttons of a keypad become too close together to press one key without inadvertently pressing another. For that reason, ancillary devices have been proposed to increased functionality. Another issue that arises is quality of image and sound, again most pertinent when the device has the smallest possible dimensions.

In response to such challenges, many ancillary devices including docking stations have been provided for a variety of personal electronic devices.

For example, huge ranges of docking stations are available for players such as MP3 players including the Apple iPod™. Such docking stations include a cradle into which the MP3 player is fitted and connects to jacks within the docking station. The docking station is often provided with integrated or separate speakers and the like to allow music to be played through the larger (and thus better quality) speakers of the docking station as compared to playing through the MP3 player itself. The docking station is often left in a room, such as of a residence or place of work, or in a vehicle, and is only used when the personal electronic device owner is present. When the owner is away from the docking station they are free to undock the personal electronic device from the docking station and carry it with them for use, as they require. The docking stations of this type are not portable in the sense of being easily carried on the person.

US patent publication No. 2007/77965 (Fox) describes a docking station for a music-enabled cell phone. The docking station has a cradle for holding the cell phone and a cable connector with a stereo headset plug at one end and audio connectors at the other end. The cradle includes a connector for recharging.

EP 1 736 847 (Vance et al) describes a universal game controller provided for use with a plurality of different types of cell phones. The controller includes a phone dock for receiving the desired cell phone. A receptor makes electrical connection to the cell phone. Control pads that are operable by fingers or thumbs are available for controlling the functionality and available on the game which can be played on the cellular phone. The controller and thus provides more traditional gaming control functionality than is available on a conventional cell phone. Without the controller, the game would have to be played by pressing specific buttons on the keypad of the cell phone.

Nyko provides a commercially available cradle for the Play Station Portable (PSP). In particular a product called the “Nyko Charger Cradle” is reported on the Internet as being available commercially. The device has been described as having a rechargeable lithium-ion battery that will keep the PSP powered for a reported additional five hours. The PSP sits into a pair of U-shaped brackets forming a cradle portion. The brackets sit atop two opposing handles that may be gripped by a user. The PSP is then played in the normal way utilising its own integral gaming control buttons.

Notwithstanding the various proposals that have been made to date, there is still a requirement to improve user interaction when using various functions of personal electronic devices such as mobile phones.

### SUMMARY OF THE INVENTION

The present inventor has invented a docking station, which allows multiple configurations for use of a personal electronic device. In particular the docking station provides a cradle into which the personal electronic device may be fitted, and acts as an adapter, allowing various additional components to be functionally connected to the personal electronic device. Of particular interest within the present invention are personal electronic devices with display screens.

In particular the present invention provides a docking station kit for a personal electronic device such as a mobile phone, the docking station kit comprising:
a docking support having defined therein:
a first compartment space in which the personal electronic device is dockable;
a second compartment space in which a modular accessory for the personal electronic device is dockable; and
at least two modular accessories which are interchangeably dockable within the second compartment space.

It is desirable that all of the configurations of docking station kit and/or docking support are designed to be hand-held for use. This allows for tactile input when handheld (from the digits of a user).

It will be appreciated that interchangeable modular accessories will typically be interchanged for different functionality. It will also be appreciated, that when the kit of the invention is in use, the modular accessories are operably connected to the personal electronic device. The interchangeable modular accessories will generally be input or output devices. The interchangeable modular accessories can thus be used to output from the personal electronic device or to input to the device, although of particular interest within the present invention are modular accessories which are tactile input devices.

Some examples of the types of modular devices contemplated for use within the present invention include
speakers;
controllers including control pads, touch pads, key pads, key boards, roller balls, joysticks, mouse devices, motion sensors, and other controllers such as game controllers and the like;
touch sensitive screens with/without tactile controls either side;
memory devices;
processing units including CPU's and hard drives;
imaging devices such as a still or video camera;
players (including those with recording or “burning” facilities) for audio, visual or audio-visual including CD, DVD, MP3, MP4, etc,
power units including AC input devices and rechargeable or non-rechargeable batteries;
connectors or adapters for facilitating connection of the personal electronic device to other functional or non-functional components;
printer devices;
TV reception devices, radio receptions devices, TV and radio reception devices; other peripherals, including modems, wireless enabling devices, readers including card readers, printers, scanners, SIM modules, VoIP modules, GPS (satellite navigation) modules, etc.
Blanks (non-functional accessories which fill out the compartment space) can also be employed if desired. These could be moulded plastic pieces.

Additionally, it will be appreciated that the accessories may have defined therein a second compartment space in which a further accessory is dockable.

It is desirable that there are at least three compartment spaces—a first compartment space in which the personal electronic device is dockable;
a second compartment space in which a modular accessory for the personal electronic device is dockable; and
a third compartment space in which a modular accessory for the personal electronic device is dockable.

This means that additional functionality can be added to the personal electronic device quite easily. The modular accessories in the second and third compartment spaces can have the same or different functionality, for example a pair of speakers or a pair of controllers, or one of each.

Generally it is desirable that second and third compartment spaces are provided on opposing sides of the (first) compartment space for the personal electronic device. This allows for input or output devices to be arranged on either side of the personal electronic device. For example in the gaming application, separate controls can be provided on either side of the personal electronic device. This is a set-up typical of many gaming consoles and which users find easy to use. Such a configuration is easily achievable by sizing the second and third compartments to substantially the same dimensions. An orientation of the assembly of the present invention where the controls of a module are to the left or right of the personal electronic device display screen in the correct viewing orientation of the display screen. This arrangement will generally be considered a “landscape” arrangement (generally the screen will be longer in the left to right direction), while the orientation where the controls of a module are at the bottom of the display screen will generally be considered a “portrait” arrangement (generally the screen will be longer top to bottom than left to right). Generally placing modular units on opposing sides of the personal electronic device will function best in the landscape arrangement.

Encompassed within the present invention is an arrangement where two or more compartments for modular accessories are on the same side (for example at one end of the personal electronic device). Such an arrangement will generally result in a landscape type arrangement.

Additionally, encompassed within the present invention, is an arrangement where two or more compartments for modular accessories are provided in a stacked arrangement—for example each under the (first) compartment space for the personal electronic device. Such additional compartments can be provided by the docking support itself. Alternatively a given modular accessory may be provided with a compartment space in which a further component is dockable. It will be appreciated that such additional compartments may be provided in either a landscape or portrait arrangement.

It will be appreciated that any number of compartment spaces can be provided.

It will be appreciated that the compartments can be constructed to any desired relative positioning arrangement. The compartments may be side-by-side, one above another, or any combination thereof. It will be appreciated that while it is desirable to have at least two compartments to which the same accessory can be interchangeably fitted, the present invention is not limited to having such compartments and one or more compartments or indeed all compartments may be differently sized.

Generally speaking, it will be desirable that the second and third compartment spaces are compatible with the same modular devices so that the modular accessories fit in both and operably connect to the personal electronic device. As will be appreciated this has many advantages mainly due to the versatile interchangeability. Furthermore, the user may prefer to swap the positions of certain modular accessories based on their preferred hand for operating the accessory such as when using hand controls.

It is desirable that any accessory is substantially accommodated within its (respective) compartment. It is also desirable that the personal electronic device is substantially accommodated within its compartment. This means that overall the assembly will have substantially flush surfaces at least when all of the compartments are in use. Generally speaking, it will be desirable that the docking support will hold the electronic device and any accessories proximate to each other. This has the advantage that the overall impression to the user is that it is an integral piece of equipment.

It is desirable that any connective arrangements such as ports, jacks, terminals, wiring or the like are accommodated internally in the assembly so that they are hidden from view in the assembly. This may be achieved by having any connective arrangements on a sidewall of the compartment. Any connective arrangements on the accessory can also be on a sidewall of the accessory. Accordingly, when the accessory is fitted into the compartment, the connective arrangements will be arranged to mate and will be hidden for view. Use of male and female connective arrangements is particularly desirable in this respect as this will help achieve substantially flush mating of the docking support and any accessory.

It is desirable that when an accessory connects it is not only attached (functionally where required) to the docking support, but that outer surface(s) of the accessory form a substantially continuous surface with the docking support and/or the personal electronic device.

It will be appreciated then that the device is completely modular in construction. Parts can be added and interchanged while the device otherwise functions as an integral unit when assembled. Generally the assembly will be of the type, which may be handheld and operated easily by one or more fingers or thumbs in the handheld position.

It will be appreciated that the, or each, accessory is physically supported by the docking support. In conventional arrangements when a device is attached to a personal electronic device the functional connection such as a jack, USB connection etc. is required to support at least part of the weight of the attached device. This means a functional connection end of the device is supported but the remainder of the device, in particular the part of the device extending away from the functional connection is unsupported.

In contrast within the present invention the docking support will provide a physical barrier which will protect (and desirably conceal) the functional connection. Furthermore the docking support will provide physical support not only at the functional connection but also for that part of the device that extends away from the functional connection.

There are many possible arrangements for providing such physical support within the compartments.

In one desirable construction the accessories push-fit to the docking support. It is desirable to achieve both functional mating of the docking support and the accessories and also further mechanical inter-engagement of the accessory and the docking support. Such an arrangement is desirable also for the personal electronic device.

One arrangement for mechanical inter-engagement is a push-fit inter-engagement such as a click-fit, snap-fit etc. Where desirable a release mechanism may be provided, for a releasable catch to allow removal of the accessory or personal electronic device as required.

One construction provides a slide fit where a slide runs within a retaining guide. The slide can take the form of a rail with an engaging portion such as an engaging head, which runs within and is retained in the retaining guide. The slide or guide can be arranged with one on the personal electronic device and/or the accessory and the other on the docking support. A compartment or accessory may be provided with a track or rail for guiding the accessory towards a correct position within the compartment.

If desired one or more connectors of any desired type can be mounted in the docking support. For example if direct connection to the personal electronic device were impeded (by the docking support) the connectors would act as intermediary connections effectively providing the same connection type as on the personal electronic device on the docking support. Devices external to the docking support could thus be attached.

In one construction a pivot arrangement is provided for allowing mating of the personal electronic device or accessory with the docking support. The pivot arrangement may be employed to allow connections on the docking support be pivoted to a position for mating with the personal electronic device or accessory and then later pivoting the mated personal electronic device or accessory back into its compartment space. This may be particularly desirable where more than one functional connection needs to be achieved. Such a pivot arrangement can be combined with all or any of the mating arrangements described above. Pivoting while retaining functional connection is thus possible.

A pivotal arrangement may also be desirable for one or more of the personal electronic device and the accessories while functionally connected (and supported) by the docking support. For example it may be desired to allow pivotal movement of the personal electronic device so as to allow a screen thereof to be held vertically or at an inclination (relative to the docking support when the docking support is substantially horizontal) for example for better viewing. Similarly it may also be desired to allow one or more accessories to be held vertically or at an inclination, for example a speaker for sound emission toward a listener. Such an arrangement may be provided, by having one or more flip-up portions on the docking support. The flip-up portion will retain the required functional connectivity while allowing the desired relative position to be set by the user. Any pivotal arrangement may comprise a support frame for the personal electronic device or accessory.

A pivotal arrangement may also be desirable between two parts of the docking station, which can pivot relative to each other. This may be useful in many configurations such as for example an arrangement where dual screens are provided. Such configurations can be easily accomplished in a side-by-side arrangement or an arrangement where one is above the other.

A pivotal arrangement is also useful in the present invention where it is desired to have flip-over functionality, for example to bring a modular accessory from an underside to an upper side.

In one construction a pivot arrangement is provided to allow open and closed configurations of the docking support. For example a cover or lid may be provided which opens for use of the personal electronic device and closes for protection thereof when not in use. If desired a plurality of covers may be provided on the docking station.

It will be appreciated that the cover can be an integral part of the docking support itself if desired. The cover can be configured so that one or more of the personal electronic device or any accessory travels with the cover as it opens or closes. Alternatively the cover can be a simple pivoting cover without any personal electronic device or accessory arranged to travel with the opening or closing movement.

In this way the modularity of the overall assembly is created and the personal device is provided additional protection by the support.

A pivotal arrangement, which allows the personal device to pivot within its compartment space, is also desirable. This arrangement may be useful in allowing the personal electronic device to be rotated. Rotation can be allowed when the docking station of the present invention is in a compact arrangement with all accessories substantially accommodated within the docking station. Additionally, this arrangement may allow the personal electronic to be held vertically or at an inclination relative to its compartment space for example for better viewing. This arrangement may also allow a personal electronic device such as a mobile phone to be used when the docking station of the present invention is in a compact arrangement.

Desirably the personal device is held by a pivotable support within a compartment. In one arrangement the pivotable support is a support frame within the compartment. This provides a simple yet highly maneuverable arrangement allowing for many configurations. Desirably pivoting of the personal device is through at least 20° such as through at least 40°, at least 50°, at least 60°, at least 70°, at least 80°, or at least 90°. It is possible to allow pivoting through at least 120°, at least 160°, at least 180° at least 200° at least 220° or at least 270° and up to 360°. In certain configurations the personal device may undergo one or more complete revolutions in a given direction.

It is desirable that the pivoting of the personal electronic device is addition to any pivoting arrangement of the docking support. Desirably the docking support has two parts which pivot relative to each other the personal device is pivotable within one part of the device. In this way the docking support can be pivoted (e.g. hinged) to open and in the open configuration the personal device is itself pivotable.

It will be appreciated that configurations of the device of the invention thus include a personal electronic device that can be pivoted to face up or face down in the open or closed configuration of the docking support.

It will be appreciated is that such arrangements include the possibility of having a docking station which has a pivot open functionality which will allow a standing screen (which will be referred to as vertical even though a large range of positions are possible) relative to a lying base (which will be referred to as horizontal even though a large range of positions are possible). For example, suitable controls can be provided on a horizontal part for input, and a screen for display on the vertical part.

Similarly it may also be desired to allow one or more accessories to pivot within their compartment spaces, in the same manner as described above for the personal electronic device. For example a speaker may be pivotable, so that when all accessories are substantially accommodated within the docking station, the docking station can be positioned for example for sound emission towards the listener while still maintaining a compact arrangement.

Such arrangements may be provided, by having one or more pivoting support frames on the docking support for example within one or more respective compartments.

In one arrangement a sliding mechanism may be employed within the docking station of the invention. This allows a slide-away arrangement of one or more of the compartments. For example one or more sliding mechanisms can be provided to allow one or more compartments for an accessory to slide relative to a compartment for the personal electronic device. This can allow extended and retracted configurations of the docking station. Such sliding arrangements will maintain any interconnection between the personal electronic device and the accessory. For example it may be desirable to have one or more slide out controllers for the personal electronic device, including one or more game controls, scrolling devices, keyboards or keypads, touch sensitive screens and combinations of same. This has the advantage that the docking station can be moved between a compact arrangement and a more extended arrangement. The compact arrangement is desirable as a non-use configuration for the accessory(ies) in question while the extended configuration is suitable for use configurations of the accessory(ies). It is desirable that in the retracted configuration the accessory(ies) are substantially accommodated within the docking station. This additionally hides them from view. This has the advantage that the overall impression to the user is that the equipment is more compact.

In one arrangement the sliding mechanism comprises a sliding drawer which will incorporate one or more compartments. In one arrangement the sliding drawer has at least one upper compartment. Alternatively or additionally the sliding drawer may have, on an underside thereof, one or more additional compartments for additional accessories. The compartments on the underside may be for smaller accessories than any upper compartment.

It will be appreciated that one or more such sliding arrangements may be provided. The sliding arrangement(s) may be formed on the underside of the docking support or at an intermediate position in the body thereof.

The sliding arrangement can have accessories both on an upper and lower side thereof.

The sliding part of the sliding mechanism is desirably part of the docking support. The compartments of the docking support are thus easily moved relative to each other. The sliding mechanism can comprise a rail with an engaging portion such as an engaging head, which runs within, and is retained in the retaining guide. The slide or guide can be arranged with one on the support part and/or one on the compartment space.

If desired the docking station may be provided with a release catch which will hold the sliding mechanism in a desired position for example the refracted or stowed position. The same release catch or an additional one may also be used to hold the sliding mechanism in an extended position.

It will be further appreciated that any of the pivoting arrangements described above can be combined with a sliding arrangement so that the part that slides can also be pivoted. This combination can include pivoting of the personal electronic device and/or one or more accessories as set out above. This can mean for example that a slide-away mechanism can be utilised to stow and reveal accessories while the pivoting arrangement can be employed to flip-over the slide-away part so that accessories on the underneath side thereof can be flipped to the upper side and vice versa. Similarly for the personal electronic device.

In one construction, a planar longitudinal member/platform extending from the first compartment provides the subsequent compartment spaces. This platform is integrally moulded with the walls of the docking support and therefore provides a rigid support for accessories, which may be supported on both the upper and under side of the platform. The accessories push fit to the docking station, thereby concealing the functional connectors within the docking support. The platform can support the back of the accessories once they have been docked within the compartment spaces, allowing a rigid support to enable the user to use the dock in hand held mode. The platform can be used either to mount multiple accessories, or a single accessory which spans the full width of the platform. It may be desirable to have one or more accessories such as a standard QWERTY keyboard arrangement, or a keyboard arrangement with a roller ball or trackball mouse device or gaming controls. A set of tactile gaming controls could be mounted. Games controllers such as the touch sensitive screen and/or push buttons of the type found on the Nintendo DS are useful in particular configurations of the present invention which allow a dual screen arrangement. It will be appreciated that either both or one of these touch screens can be programmable. In one desirable arrangement a touch sensitive input screen is employed. Desirably the screen is programmable to display tactile input keys. Examples include different alphabet characters such as those for Chinese, Korean, Japanese or Cyrillic or a standard Qwerty keyboard. This enables a user to interact with the personal electronic device in a language of choice. The programmable display would not be confined to displaying keyboard style keys and could be configured to allow input of any desired character. Additionally or alternatively it could be programmed to display one or more control buttons.

In a further embodiment of the present invention, it may be desirable to have one or more accessories such as an external CPU or the like which would increase the performance capability of the personal electronic device. For example, an external graphics engine may be used to increase the graphics performance of the screen to enable the user to play an extended selection of games.

In an alternative embodiment, an external modem such as a narrowband modem or a radio frequency modem could be used to enable a faster connection to the Internet.

It will be further appreciated these accessories can also be used with any of the configurations previously described

It will also be appreciated that more than one personal electronic device can be accommodated with any of the configurations described.

Desirably at least the compartment of the docking support for the personal electronic device include one or more grips for assisting in the retention of the device within the docking support. The compartment spaces will generally be rectangular in shape. In such a case it is desirable to have such grips (internally) on at least one, for example all, of the corners.

Desirably at least one, and more suitably all of the compartments of the docking support include one or more dampers, for absorbing shock, in the assembled configuration. This allows for impact-resistance for example when the device is inadvertently dropped or is subjected to a knock. Where the compartment spaces are substantially rectangular it is desirable to have such grips (internally) on at least one, for example all, of the corners. It will be appreciated that the grips may form the dampers and vice versa. For example grips of resiliently deformable material such as rubber could be employed.

In one arrangement where the personal electronic device or an accessory has a camera an opening such as an aperture or window may be provided in the docking support to allow images to be recorded without interference. In one arrangement the camera is connected to the personal electronic device so that the personal electronic device can display the image being captured and desirably all functionality of the camera.

In one arrangement the docking support comprises a substantially planar longitudinal member upon which compartments are defined by one or more upstanding walls. Desirably at least said first and second compartments and suitably all compartments are defined in this way. It is desirable to have each personal electronic device or accessory within a compartment defined by the longitudinal member and at least two upstanding walls (each on a different side of the device to the other). The compartments act as bays into which the accessories (or personal electronic device) dock. In this way the modularity of the overall assembly is created. In some embodiments it may be desirable to have the personal electronic device held within four walls (in a rectangular configuration).

Any or each compartment can be provided with a base that physically supports the personal electronic device or accessory. For example the planar member can extend to form a (floor) support pan for any compartment. The support pan can be a closed surface such as a floor or an open surface such as a support frame (which may run about the periphery of the personal electronic device or accessory—e.g. in the form of a rim). It is desirable that the support pan extends to support at least 50%, more desirably substantially all, of the personal electronic device or accessory.

Desirably when assembled, the personal electronic device or accessory is pushed into place and is gripped by any arrangement described above. Indeed the personal electronic device or accessory may couple with the docking support so that the personal electronic device or accessory is held firmly against the planar member. For compartments above the planar member it will normally form the base of the compartment while it may be considered to form a roof of any compartment disposed below the planar support.

Also within the present invention is a docking support having defined therein:
a first compartment space in which the personal electronic device is dockable;
a second compartment space in which a modular accessory for the personal electronic device is dockable.

It will be appreciated that the docking station of the present invention may itself have many alternative configurations.

In one embodiment of the present invention, the docking support further comprises a pivotable arrangement for the docking support and any accessory while functionally connected to the docking support. A pivotal arrangement may be desirable for one or more of the personal electronic device and the accessories while functionally connected (and supported) by the docking support.

For example it may be desired to allow pivotal movement of the personal electronic device so as to allow a screen thereof to be held vertically or at an inclination (relative to the docking support when the docking support is substantially horizontal) for example for better viewing, for example a keyboard and screen arrangement so the keyboard is arranged on the horizontal and the personal electronic device is held at an angle of less than 180° with the keyboard. It will be appreciated that is may be desired to allow the personal electronic device and any accessory when docked to be held at a fixed angle (on a viewing side) of less than 180° to each other.

Similarly it may also be desired to allow one or more accessories to be held vertically or at an inclination, for example a speaker for sound emission toward a listener.

In one arrangement the docking support further comprises at least two parts that can pivot relative to each other.

In a further embodiment the docking station further comprises a pivotable support frame within one or more compartment spaces so that one or more of the personal electronic device or any accessory can pivot within the compartment space while functionally connected to the docking support.

In a further embodiment the docking support further comprises a sliding mechanism to allow the second compartment to slide relative to the first. This allows a slide-away arrangement of the compartments. For example a sliding mechanisms can be provided to allow one or more compartments for an accessory to slide relative to a compartment for the personal electronic device. This can allow extended and retracted configurations of the docking station.

Generally it is desirable that the hand held docking support further comprises a moveable connector for electronically connecting to the personal electronic device and a second connected position in which the personal electronic device is docked. This allows for the electronic device to be easily mounted in the docking station. Additionally this allows for a compact fit of the electronic device within the first compartment and has the advantage that the overall impression to the user is that the equipment is more compact.

It will be appreciated that a docking station of the present invention may also be adapted so as to be itself dockable in a (second) docking station. That is the docking station can dock in a further docking station and provides desired interconnectivity to the further docking station. Some examples of the types of docking stations include GPS cradles, mobile phone cradles, PDA cradles, in car entertainment cradles etc.

It will be appreciated that within the docking support of the present invention, the above features can be used alone or in combination.

The invention also includes a modular accessory adapted to mate to a docking support of the present invention.

In one embodiment the present invention provides a modular accessory for attaching to a hand-held docking support for a personal electronic device or directly to the personal electronic device the accessory having defined therein: a first compartment space in which a further accessory is dockable.

In another embodiment the accessory has defined therein a second compartment space in which a further accessory is dockable. It will be appreciated that the modular accessories can have a plurality of compartment spaces. Desirably the, or each further accessory is modular. Optionally the modular accessory further comprises both an electronic connector for electronically connecting, and a mechanical connector for mechanically connecting the accessory to the docking support or the personal electronic device.

The invention further extends to a docking station kit for a personal electronic device such as a mobile phone, substantially as described herein with reference to the drawings.

The invention also extends to a docking station substantially as described herein with reference to the drawings.

### BRIEF DESCRIPTION OF THE DRAWINGS

FIG. 1 shows a perspective view of the docking station with accessory devices arranged to engage the compartments of the docking station.

FIG. 2 shows a perspective view of the docking station with two compartments occupied by accessory devices.

FIG. 3 shows a perspective view of the personal electronic device docking in the first compartment of the docking station.

FIG. 4 shows a perspective view of the docking station with all compartments occupied.

FIG. 5 displays a plan view of the docking station with a number of different accessories that are interchangeable at the docking station compartments.

FIG. 6 (a) (b) and (c) shows a plan view of possible portrait configurations of the docking station.

FIG. 7 displays a docking station with three compartments arranged in a landscape configuration with the first compartment occupied by a recorder and the other compartments on either side of the recorder occupied by speaker accessories.

FIG. 8 illustrates a perspective view of the docking station, with all its compartments occupied, when in use.

FIG. 9 shows a perspective view a docking station arranged in a landscape configuration in which the compartments can pivot.

FIG. 10 provides a perspective view of the docking station after the compartments have been pivoted.

FIG. 11 provides a side view of the docking station in which the personal electronic device positioned in the first compartment is a camera.

FIGS. 12(a)-(e) each provide a perspective view of various configurations of a docking station of the invention with a slide-away arrangement for one or more compartments and respectively showing: (a) the slide-away compartment in an extended position and an accessory to be fitted to the docking station beneath the slide-away compartment; (b) a slide-away compartment in an extended position and a keyboard accessory thereon and a personal electronic device arranged to be seated in the first compartment; (c) a slide-away compartment in an retracted (stowed position) position with an accessory thereon and compartments on the underside of the docking station with the exception of one being occupied and an accessory arranged to engage with the remaining empty compartment; (d) a slide-away arrangement in an extended position and one accessory thereon and a personal electronic device docked in the first compartment; (e) a docking station with all its compartments occupied and with a slide-away compartment in a stowed position.

FIGS. 13(a)-(b) each provide a perspective view of various configurations of a docking station of the invention with a fold-away arrangement for one or more compartments and respectively showing: (a) a perspective view of the docking station in which a personal device is arranged to engage the first compartment, and the fold-away arrangement in its opened out configuration for use; and (b) the fold-away arrangement in its closed configuration for storage

FIG. 14 provides a perspective view of a docking station of the invention in which a personal device is engaged with the first compartment and accessories are arranged to engage with compartments on either side of and below the first compartment.

FIG. 15 provides a perspective view of the docking station of FIG. 14 with all compartments occupied.

FIG. 16(a) to (e) provides a perspective view of the docking station of the invention in which a personal device is engaged with the first compartment with a Qwerty keyboard (FIG. 16a) accessory and a tactile games controller (FIG. 16b) a tactile games controller with a touch screen (FIG. 16c) and a touch screen (FIG. 16d) engaged in the second compartment space. FIG. 16(e) shows the docking station of the present invention with the second compartment space empty and a number of accessories ready to engage the second compartment space.

FIGS. 17 (a) and (b) provides a perspective view of the docking station with a personal electronic device engaged in the first compartment space and the modular accessory comprises both a mechanical and electrical connection for connecting to the personal electronic device. The modular accessory has defined further compartment spaces in which further accessories are dockable.

FIG. 18 provides a perspective view of the docking station with a personal electronic device engaged in the first compartment space and a modular keyboard mechanically and functionally connected. A second accessory in the form of a games controller with a touch screen is available to be interchanged with the keyboard. Both the keyboard and the games controllers have compartment spaces for additional accessories defined therein. Additional modular accessories are available on either side of the dock to be engaged with the docking support.

FIG. 19 (a) shows a perspective view of a personal electronic device engaged in a first part of a docking station, which defines a compartment including a pivoting support frame for the personal electronic device. FIG. 19(b) shows a perspective view of a second part of a docking station and which defines a compartment for receiving an accessory. FIG. 19(c) shows the second part of the docking station of FIG. 19(b) with the accessory engaged therein. FIG. 19(d) provides perspective views of the two parts of the assembled docking station pivotally connected to each other and with the personal electronic device engaged in the first compartment space and the accessory mechanically and functionally connected.

FIGS. 20 (a) and (b) each provide a side view of the assembly of FIG. 19(d) in closed and open configurations respectively.

FIG. 21(a) provides a side view of the assembly of FIG. 19(d) in an open configuration with the support frame arranged for rotation within the compartment space from an aligned position shown in dashed outline while FIG. 21(b) shows a pivoted position of the personal electronic device.

FIGS. 22 (a), (b) and (c) provide respective perspective views of an arrangement similar to FIGS. 19 and 20, wherein in FIG. 22(a) the assembly is in a working (open) configuration with a first part in a generally vertical position relative to the second part which is horizontal. In FIG. 22(b) a closed configuration is shown, wherein the personal electronic device is orientated face down. In FIG. 22(c) the personal electronic device is orientated face up.

### DETAILED DESCRIPTION OF THE DRAWINGS

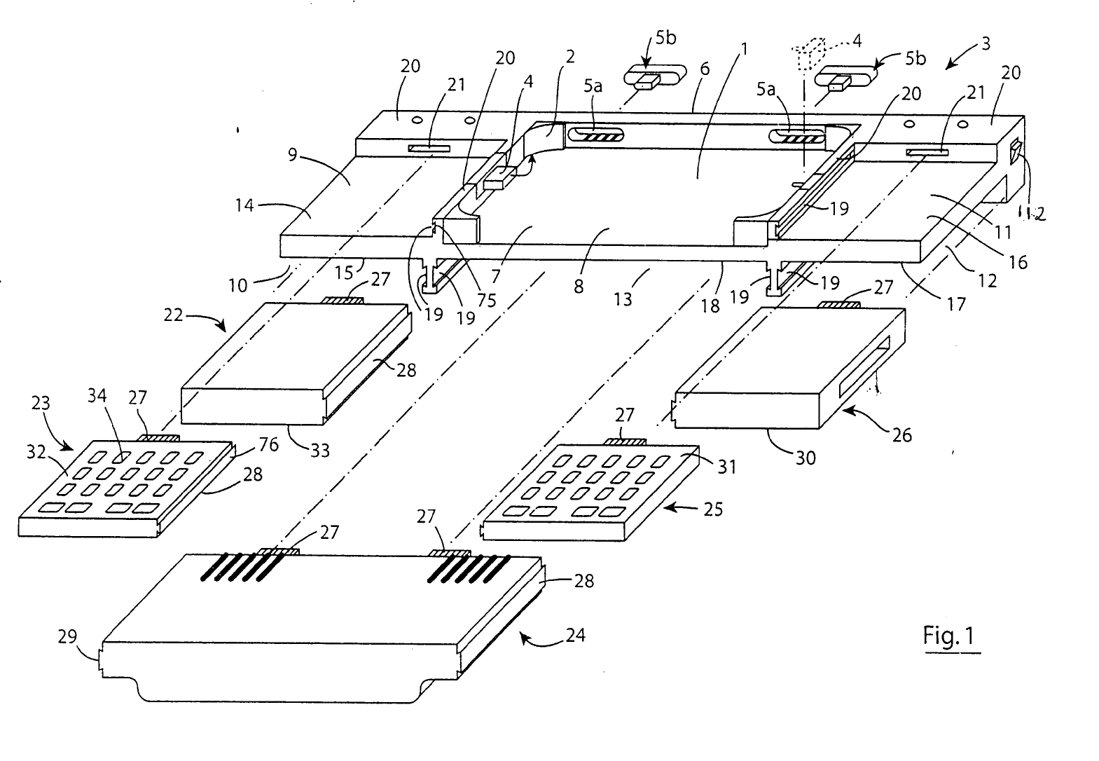

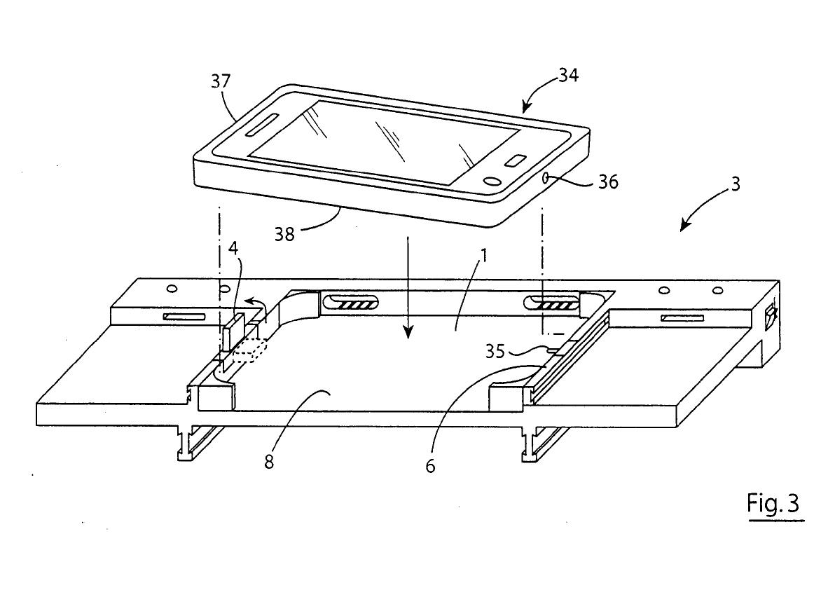

FIG. 1 shows a docking station 3 for a personal electronic device such as a mobile phone. The docking station provides a first compartment 1 into which the personal electronic device may be fitted. The first compartment 1 is defined by a docking support in the form of a frame or rim 6 having sidewalls of suitable material. An open end 7 of the rim 6 allows for easy removal of the docked personal device. The rim 6 may extend about the compartment and be provided with a removable sidewall that can be removed to facilitate the removal of the docked personal device. The first compartment 1 of the docking station 3 shown in FIG. 1 has a floor pan or platform 8 that can support the back of the personal device once it has been docked within the first compartment. The first compartment 1 is substantially rectangular and has at each corner thereof rubber grips 2 arranged to secure the docked personal device within the docking station. The rubber grips may further provide a damping means to protect the personal device. In addition to the rubber grips, the first compartment is further provided with an adjustable connector 4 which may be functionally attached for anchoring the personal device within the docking station. The adjustable connector 4 shown in FIG. 1 can swivel (see FIG. 3) to facilitate engagement with the personal device as the personal device is applied to the docking station. Once the personal device is docked it is retained in place within the first compartment 1 by the connector 4 and the grips 2.

Connective arrangements 5a, 5b are provided along the rim 6 within the first compartment 1. The connective arrangements shown in FIG. 1 are apertures 5a with connectors therein which couple to ports 5b. The connectors engage a terminal of the personal device when docked. Each of the connective arrangements 5a, 5b are located within the frame 6 so that they are maintained internally within the docking station compartment and are not visible (externally) once the personal device has been docked HI in the compartment. Connection to the personal electronic device may be achieved from the exterior of the docking station 3. The connective arrangements 5a, 5b are not restricted to ports and in further embodiments of the invention the connective arrangements are jacks, terminals, wiring or the likes. The docking station 3 can accommodate any number of interchangeable controls. A release switch 112 is provided that can aid in the removal of connected accessory modules or the removal of the personal electronic device 3.

FIG. 1 shows additional compartments 9, 10, 11, 12 and 13 in which a modular accessory for the personal electronic device is dockable. Each of the compartments is provided with a platform 14, 15, 16, 17 and 18 that supports the modular accessory of the personal electronic device when docked. Sidewalls 20 define the edges of each compartment. The dimensions of each of the compartments 9, 10, 11 and 12 are substantially equal. The embodiment shown in FIG. 1 illustrates additional compartments 9 and 11, which are provided on opposing sides of the first compartment 1 for the personal electronic device. Compartments 10 and 12 are on the under surface of the docking station and lie opposite compartments 9 and 11 respectively. Compartment 13 is on the under surface of the docking station and lies opposite the first compartment 1. Compartment 13 is arranged to receive a power source in the form of a battery pack 24 and in this embodiment the dimensions are larger than the compartments 9, 10, 11 or 12, which are arranged to receive the smaller modular devices. The arrangement of compartments allows for modular devices to be arranged on either side of the personal electronic device.

A connective arrangement 21 is provided in each additional compartment 9, 10, 11, 12 and 13. The connective arrangement shown in FIG. 1 is a port for receiving a plug on the modular device, however the connective arrangement may be a terminal, jack or wiring. The connective arrangement may further function as an anchoring means to anchor the modular accessory within the additional compartment. The connective arrangements 21 are located within apertures in the sidewalls 20 so that they are no longer visible within the compartment when the additional compartment is occupied. The modular accessories push fit into the port located at each additional compartment.

Each additional compartment 9, 10, 11, 12 and 13 is provided with a guiding means located on the sidewall 20 of each compartment. The guiding means can be used to guide the modular accessory to the correct position on the docking station 3. In FIG. 1 the guiding means is a track 19 which a modular device can engage. The track 19 is provided with an engaging head 75 that allows for engagement with the track. Once the modular device has engaged the track by slotting the rail 28 into the track so as to engage the engaging head 75, the module or device will be retained within the track and can slide along the track. The track 19 will guide the modular device so that the plug on the modular device is in a position to engage the port 21 (the port may be a male or female connective arrangement). In further embodiments the track is located on the platform of each compartment. Additionally engaging means can be provided on opposing sides of the walls.

FIG. 1 also shows the arrangement of the modular devices. Each modular device 22, 23, 24, 25 and 26 comprises a male or female (in the embodiment male) connective arrangement 27 for engaging a corresponding female or male connective (in the embodiment female) arrangement 21 at the relevant compartment of the docking station. Each modular device is provided with a rail 28 that is suitable for engaging the track 19 on each compartment of the docking station. The head of the rail 76 can engage the engaging head 75 of the track 19. It is clear from FIG. 1 that the additional compartment 13 is provided with two tracks 19 on either side of the compartment, therefore the modular device 24 that is to be docked within additional compartment 13 is provided with two corresponding rails 28 and 29 on either side of the modular device 24, that can engage each of the tracks 19 on either side of the additional compartment 13. The exterior surfaces 30, 31, 32 and 33 of the respective modules will each have functional features such as speakers, buttons or screens. The exterior surfaces 31 and 32 of devices 25, 28 as shown in FIG. 1 are keypads provided with individual key buttons 34. The dimensions of each of the modular devices are substantially equal to dimensions of their corresponding compartments.

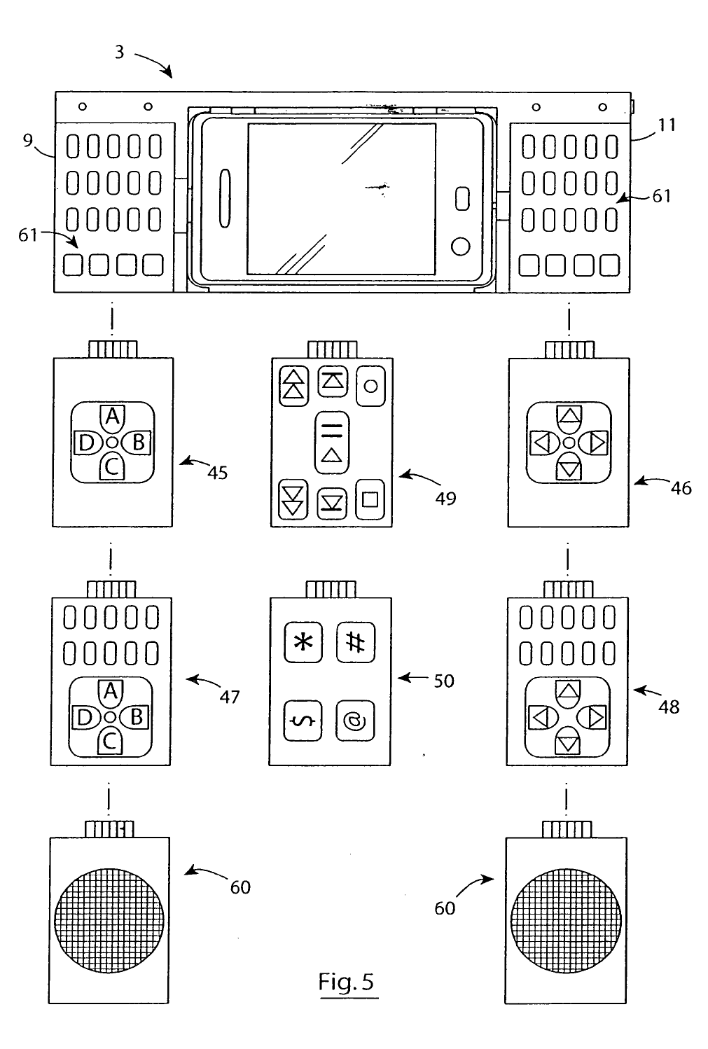

FIG. 5 shows the possible modular devices that could be positioned in the compartments 9, 10, 11 or 12. The modular devices shown in FIG. 5 push fit to the docking station 3. A release mechanism may be provided to facilitate removal of the HI accessory. FIG. 5 illustrates that the modular devices are interchangeable and will typically be interchanged for different functionality. It will be appreciated, that when the invention is in use, the modular accessories are operably connected to the personal electronic device. The interchangeable modular accessories will generally be input or output devices. The interchangeable modular accessories can thus be used to output from the personal electronic device or to input to the device. FIG. 5 displays some examples of the types of modular devices that can be used, these include opposing hand controls such as gaming control pads 45 and 46 or alternatively gaming control pads with additional text capability 47 and 48. Modular devices in the form of an audio, visual or audiovisual control pad 49 or customised control pads 50 are also possible. Modular devices such as speakers 60 and keypad comprising text buttons 61 are further possibilities.

Some other examples of the types of modular devices which are contemplated for use within the present invention include; controllers including control pads including touch pads, key pads, key boards, roller balls, joysticks, mouse devices, motion sensors, and other controllers such as game controllers and the like; memory devices; processing units including CPU's and hard drives; modems, imaging devices such as a still or video camera; players (including those with recording or “burning” facilities) for audio, visual or audio-visual including CD, DVD, MP3, MP4 etc, power units including AC input devices and rechargeable or non-rechargeable batteries; connectors or adapters for facilitating connection of the personal electronic device to other functional or non-functional components; other peripherals, including wireless enabling devices, readers including card readers, printers, scanners, SIM modules, SMS modules, VoIP modules, GPS (satellite navigation) modules etc. Blanks (non-functional accessories which fill out the compartment space) can also be employed if desired. These could be moulded plastic pieces.

The modular devices provide additional functionality that can be added to the personal electronic device quite easily. The compartments 9, 10, 11, 12 and 13 may comprise any combination of these modular devices. Therefore it is possible that each of the compartments comprise modular device each with a different functionality or alternatively two or more of the additional compartment 9, 10, 11, 12 or 13 may comprise similar or identical modular devices that provide the same function, for example a pair of speakers or a pair of controllers. FIG. 5 illustrates the docking station comprising keypads comprising text buttons 61 with similar function located at each compartment 9 and 11. Together these modular units could form a keyboard for example the “Qwerty” type, “Piano” style, or Chinese character input. As illustrated one or all of these keypads 61 could be replaced by any of the other modular devices 45, 46, 47, 48, 49, 50 or 60. The dimensions and connective arrangements of each of the modular devices are identical to facilitate interchangeability. The dimensions of each modular device are substantially the same as the dimensions of additional compartments 9, 10, 11 and 12.

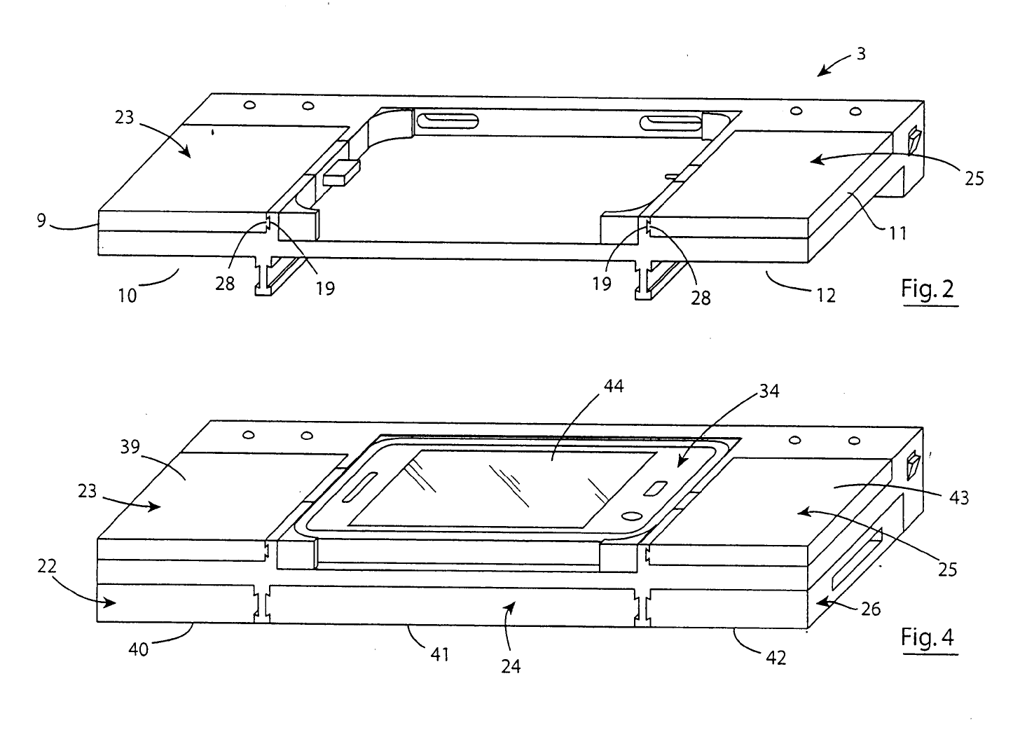

FIG. 2 shows the docking station 3 with additional compartments 9 and 11 occupied with modular devices 23 and 25 respectively. Since the dimensions of the modular devices 23 and 25 are substantially the same as the dimensions of their corresponding compartments 9 and 11 a snug fit is provided in which the edges of the modular devices are flush with the edges of the docking station 3. The rail 28 provided on each of the modular devices 23 and 25 has engaged the track 19 in each additional compartment 9 and 10 and guided into a position in which the connective arrangement 27 on the modular device 23, 25 has engaged the port 21 provided at the additional compartments 9 and 10. Once docked, the rail 28 remains engaged with the track 19 and provides an anchor that secures the modular device within the compartment. The connecting arrangement 27 also contributes to anchoring the modular device within the compartment.

Generally speaking, it will be desirable that the additional compartment spaces 9, 10, 11 and 12 are compatible with the same modular devices so that the modular accessories fit in either compartment and operably connect to the personal electronic device. As already outlined in FIG. 5 this has many advantages mainly due to the versatile interchangeability. Furthermore, the user may prefer to swap the positions of certain modular accessories based on their preferred hand for operating the accessory such as when using hand controls.

FIG. 3 illustrates how to dock the personal electronic device 34 at the first compartment 1 of the docking station 3. The embodiment shown in FIG. 3 comprises a connector 4 in addition to a further connector, which is an audio jack 35. Both connectors are positioned along the sidewalls 20 of the first compartment 1. The personal electronic device 34 comprises ports 36 and 37 arranged to engage the connectors 4 and 35.

To dock the personal electronic device 34 at the docking station 3 the personal electronic device 34 is orientated at an angle so that the audio jack can be first engaged.

Subsequently the opposite side of the personal electronic device 34 is pushed into position so that the base 38 of the personal electronic device 34 is almost parallel with the platform 8. At this point the adjustable connector 4 can be pivoted to begin to engage the port 37 located on the personal electronic device 34. The personal electronic device 34 is pushed into the compartment until the base of the personal electronic device 34 is on the platform 8. As the personal electronic device 34 approaches a parallel orientation the adjustable connector 4 simultaneously pivots to engage the port 37 more. Once the base 38 of the personal electronic device 34 is completely parallel with the base 8 of the first compartment 1 the adjustable connector 4 has completely engaged the recess to secure the personal electronic device 34 within the first compartment 1. The invention is not limited to one adjustable connector or anchoring means as any number of either type may be used. Furthermore the connector or anchoring means may be located in alternative suitable positions.

FIG. 4 shows the docking station 3 with each compartment 1, 9, 10, 11, 12 and 13 occupied. The dimensions of each of the modular devices 22, 23, 24, 25 and 26 and the personal electronic device 34 are such that a snug fit is achieved in which the edges of the modular devices and personal electronic device 34 are flush with the edges of the docking station and are flush with each other. The exposed surfaces 39, 40, 41, 42, 43 and 44 are substantially flat so that the overall surface of fully occupied docking station is substantially flat. Each of the components fit into their respective compartments so that no gaps exist between any of the components and the docking station and a substantially continuous surface is thus provided. FIG. 4 illustrates that the docking station will hold the electronic device and any accessories proximate to each other in such a way as to give an overall impression to the user that it is an integral piece of equipment.

FIG. 4 also displays how any connective arrangements such as ports, jacks, terminals, wiring or the like are accommodated internally in the assembly so that they are hidden from view in the assembly. This is achieved by having any connective arrangements on a sidewall of the compartment. Any connective arrangements on the accessory can also be on a sidewall of the accessory. Accordingly, when each of the accessories or modular devices 22, 23, 24, 25 and 26 is fitted into their compartments, the connective arrangements will be arranged to mate and will be hidden for view. Use of male and female connective arrangements is particularly desirable in this respect as this will help achieve substantially flush mating of the docking support and any accessory. The docking support thus acts as a template to which modular accessories fit.

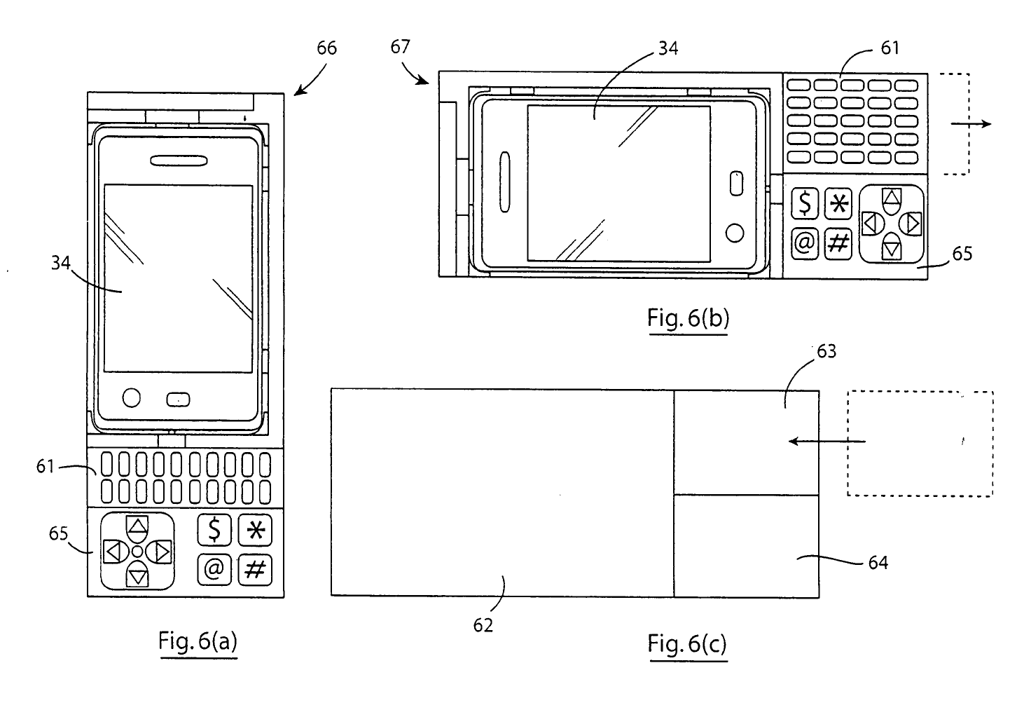

Encompassed within the present invention is an arrangement where two or more compartments for modular accessories are on the same side (for example at one end of the personal electronic device). Examples of such embodiments are illustrated in FIG. 6. One general template for such an arrangement is outlined in FIG. 6 (c). FIG. 6 (c) shows an orientation of the assembly of the present invention where the controls of a module 63,64 are to the right in the correct viewing orientation of the display screen.

Such an arrangement will generally result in a landscape type arrangement. While FIG. 6(c) illustrates a single compartment 62 suitable for receiving the personal electronic device and two compartments 63,64 suitable for receiving any one of the modular devices, it will be appreciated that any number of compartment spaces can be provided, for example two compartments may be provided, one for the electronic device and the other for receiving a single modular device. FIG. 6(b) shows the functional side of the assembled kit of the invention.

FIG. 6(a) illustrates a possible portrait arrangement where the controls are underneath the personal electronic device. FIG. 6(a) positions the electronic personal device in the upright position with both modular devices 61 and 65 traversing the width of the docking station 66 below the electronic personal device. In this particular embodiment the docking station 66 is preferably held in an upright position (portrait position) so that the personal electronic device is always above the modular devices.

FIG. 6(b) displays an alternative arrangement in which the personal electronic device and modular devices 61 and 65 are positioned longitudinally. In this orientation the docking station 67 is preferably held in a longitudinal position so that the personal electronic device is on the same longitudinal plane as the modular devices. It will be appreciated that the compartments can be constructed to any desired relative positioning arrangement and there may be one or more compartments. The compartments may be side-by-side, one above another, or any combination thereof.

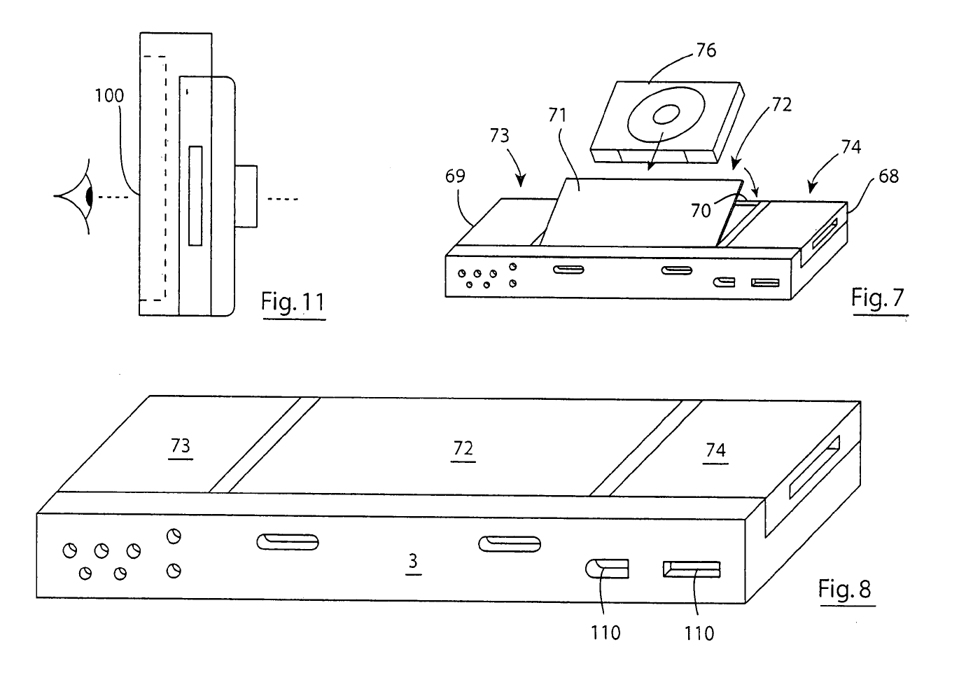

An alternative arrangement, such as that shown in FIG. 6(a) includes a portrait orientation in which the orientations of the controls of the module are substantially aligned to the correct viewing orientation of the display screen. Generally placing modular units on opposing sides of the personal electronic device will result in the landscape arrangement. It will be appreciated that while it is desirable to have at least two compartments to which the same accessory can be interchangeably fitted, the present invention is not limited to having only one such compartment and one or more compartments or indeed all compartments may be differently sized. The arrangement illustrated in FIG. 7 provides an example of a landscape arrangement.

FIG. 7 shows a fully occupied docking station comprising 3 compartments. Compartments 68 and 69 are occupied with modular devices 73, 74 and the personal electronic device 72 located in the central compartment 70 is a recorder 72 that can receive and play audio, visual or audio-visual content such as from disk 76. Compartment 68 and 69 are occupied with sound speaker modular devices 73, 74 and the docking station is arranged in a portrait configuration with each of the modular devices flanked on either side of the recorder 72. The deck 71 of the recorder 72 may be opened to allow for loading of disc 76, once the loading is complete the deck may be shut and played. The display may be that of the device 72 itself, or as an alternative, the device may be connected to another device (as set out above), which acts at the display.

FIG. 8 illustrates the compact arrangement of the fully occupied docking station 3 once the lid of the recorder 72 is shut. It is clear that each modular sound device 73, 74 is substantially accommodated within its (respective) compartment. It is also evident that the personal electronic device is substantially accommodated within its compartment. The overall assembly will have substantially flush surfaces at least when all of the compartments are in use. FIG. 8 shows that the docking station will hold the electronic device and any accessories proximate each other. This has the advantage that the overall impression to the user is that it is an integral piece of equipment.

FIG. 8 also illustrates how any connective arrangements such as ports, jacks, terminals, wiring or the like are accommodated internally in the assembly so that they are hidden from view in the assembly. This is achieved by having any connective arrangements on a sidewall of the compartment. Any connective arrangements on the accessory can also be on a sidewall of the accessory. Accordingly, when the accessory is fitted into the compartment, the connective arrangements will be arranged to mate and will be hidden for view. Use of male and female connective arrangements is particularly desirable in this respect as this will help achieve substantially flush mating of the docking support and any accessory. External connection ports 110 are provided which allow the docking station to connect to one or more external devices. The external connections may connect to one or more input or output devices that are located outside the device, for example sound speakers. The external connections may also be used to connect to one or more modular devices that are located remotely to the docking station. The external connections can be one of firewire ports, USB ports, speaker ports, battery charger ports and any other types of ports allowing connection any input or output device. It will be appreciated that any of the other embodiments of the invention may also comprise external connection ports 110.

It will be appreciated then that the device is completely modular in construction. Parts can be added and interchanged while the device otherwise functions as an integral unit when assembled. Generally the assembly will be of the type that may be handheld and operated easily by one or more fingers or thumbs in the handheld position.

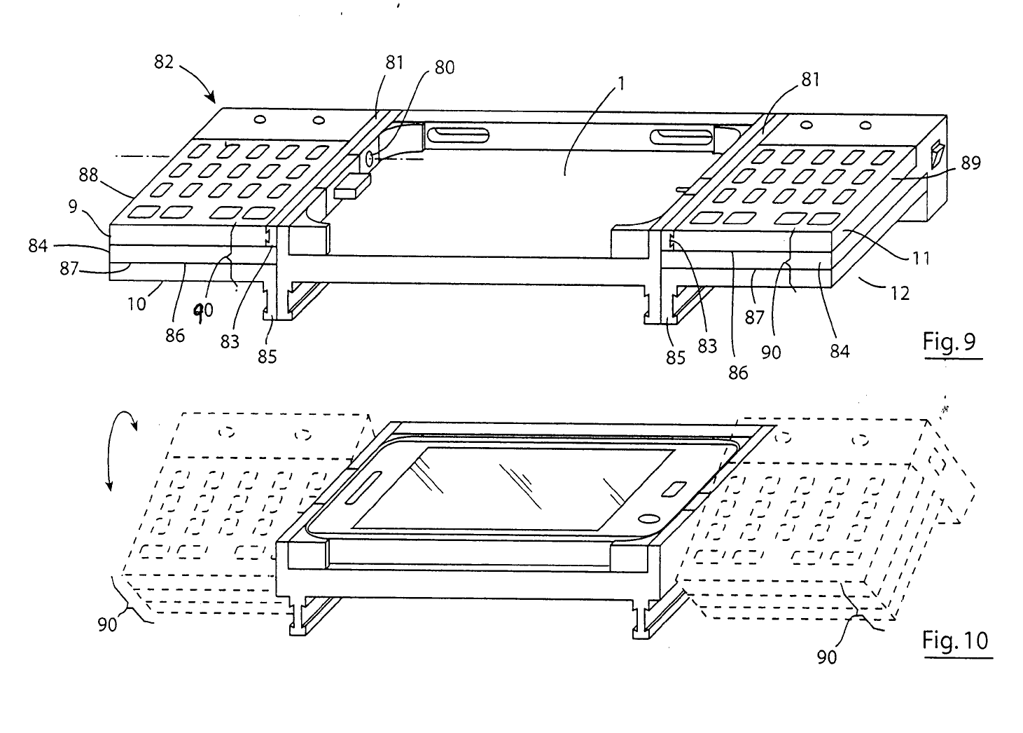

FIG. 9 shows a further embodiment of the invention in which compartments 9, 10, 11 and 12 can pivot about a pivot 80. FIG. 9 shows the pivot 80 arranged to connect with the sidewall 81 of compartments 9 and 11. In such a configuration the platform 84 of compartments 9, 10, 11 and 12 is attached to the sidewall 81 along line 83. Lower rims 85 are in turn connected to the undersurface 87 of platform 84 along line 86, so as to form a stacked pivotable arrangement 90 on either side of the first compartment 1. The stacked pivotable arrangement 90 illustrated in FIG. 9 comprises modular devices 88,89, sidewalls 81, platforms 84, and lower sidewalls 85. The sidewall 81 forms the only connection of the stacked pivotable arrangement 90 to the docking station 82. The sidewall 81 is connected to the docking station 82 through the pivot 80. The pivot 80 allows the stacked pivotable arrangement 90 to pivot in a clockwise or anticlockwise direction. A locking means may be provided which can be used to lock the stacked pivotable arrangement 90 so that it cannot pivot about pivot 80. In further embodiments the pivot may be positioned to connect with platforms 84 with the remaining elements of the stacked pivotable arrangement 90 attached to the platform 84. It will be appreciated that it is also possible to have the electronic devices pivot also, for example the personal electronic device may flip-up to a desired display angle.

FIG. 10 shows the docking station of FIG. 9 in which the stacked pivotable arrangement 90 has been pivoted about pivot 80 to a desired position. FIG. 10 illustrates that the stacked pivotable arrangement 90 can be pivoted in a clockwise or anticlockwise direction.

FIG. 11 shows a further embodiment of the invention wherein the personal electronic device is a camera. In such an embodiment the docking station further comprises an opening such as a window 100 to allow images to be recorded without interference. In a further arrangement the camera may be connected to the personal electronic device so that the personal electronic device can display the image being captured and desirably all functionality of the camera.

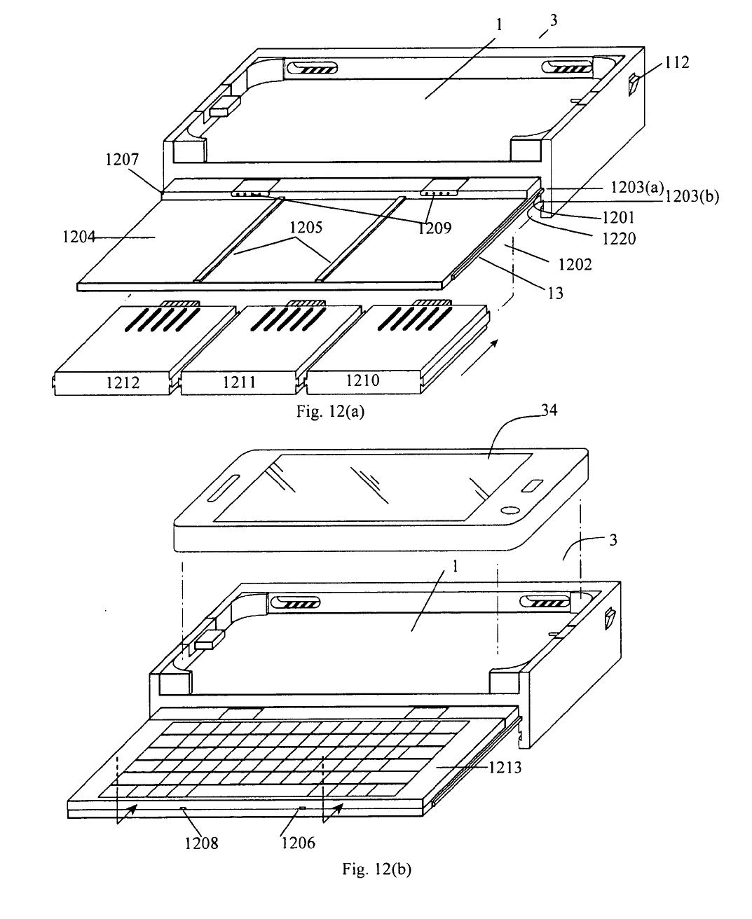

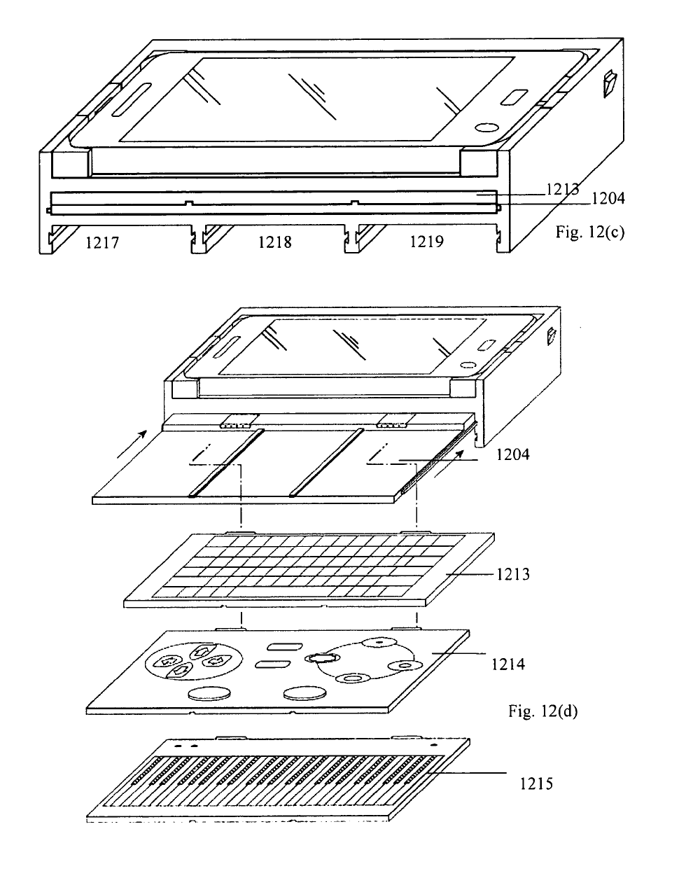

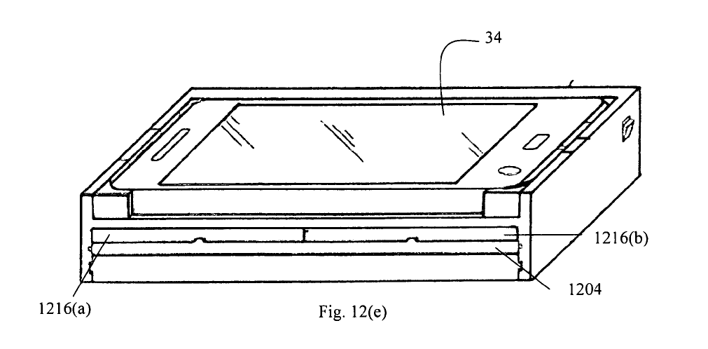

In FIG. 12 a sliding mechanism is employed within a docking station of the invention. This allows a slide-away arrangement of one or more of the compartments. In FIG. 12(a) compartment 13 is on the under surface of the docking station and lies opposite the first compartment 1. Compartment 13 in this embodiment is provided with two storage areas 1201 and 1202. Both of the storage areas are provided on the docking station 3. Each are provided with guiding means in the form of tracks, respectively labelled 1203a; 1203b which allows movement between an extended position (FIG. 12(a)) and a stowed position (for example as shown in FIG. 12(c)). These guiding means can be used to respectively guide modular accessories (for example those labelled 1210-1212) or a slide-away compartment in the form of a platform, drawer or carriage 1204 to their respective positions on the docking station 3. The tracks 1203a; 1203b are provided with an engaging head 1220 which allows for engagement with the track by slotting the rail 1221 into the track so as to engage the engaging head 1220.

The slide-away platform 1204 will be retained within the track 1203a and can slide along the track. Engaging means 1220 are provided on opposing sides of the walls. A similar mechanism can be employed in storage area 1202 to store either a single accessory (see for example FIG. 12(e)) or can be subdivided into separate compartments 1217, 1218 and 1219 to contain a number of accessories (as in FIG. 12(c)).

A release catch 112 can also be used to hold the sliding mechanism in a desired position for example the retracted or stowed position. The same release catch 112 can be used to release the sliding mechanism to allow the platform 1204 to move to an extended position.

In the embodiments shown one or more accessories may be provided on the sliding platform 1204. The accessories are modular. It will be appreciated that any modular accessory carried on the platform will move with the platform as it moves.

The slide-away platform may be adapted to carry a plurality of accessories. In particular an upper carrying surface of the platform may be divided into separate compartments if desired as can be seen in FIG. 12(e).

One method of engaging the modular accessories is shown. In FIG. 12(a) guiding means are shown on the upper surface of the tray 1204. These guiding means in this case are in the form of spaced apart rails 1205.

On the module or device is a track 1206, which is provided with an engaging head 1208 as shown in FIG. 12(b). Slotting the rail 1205 and the track 1206 together, and sliding the track along the rail may place the modular accessory into position. Connective arrangements in the form of push-fit connectors or the like, 1209 are provided on the sliding platform along the wall 1207. These connective arrangements allow the modular accessories to functionally connect to the personal device.

Optionally the slide-away compartment can be removed from the assembly and replaced with a modular accessory.

The dimension of the tray and modular device together are substantially equal to the dimensions of their corresponding compartments. This means that when the slide-away arrangement and its attached accessories are in the stowed position the compartment in which they are received is substantially filled. These modular accessories can be additional power sources, memory modules, card readers (such as SD card readers) PCM-CIA card slots, wireless card slots, SIM modules, GSM modules, GPS/GPRS modules etc. Blanks can also be employed if desired. Alternatively these compartment spaces can be used as storage for devices such as remote controls.

FIG. 12(b) shows an extended configuration of the docking station with a keyboard 1213 engaged with the slide-away platform 1204. This unit could be a Keyboard of the “Qwerty” type or any other modular accessory such as a games controller 1214 or a piano type keyboard 1215 as show in FIG. 12(d). FIG. 12 (b) also shows how a personal electronic device 34 fits into the docking station 3.

FIG. 12(c) shows a retracted or stowed configuration of the docking station. In this instance, the slide-away compartment 1204 and accessory 1213 are positioned entirely within the docking station and in particular in compartment 1201. FIG. 12(d) shows different tactile input devices that can be employed with the present invention.

FIG. 12(e) shows the slide away platform 1204 where the upper carrying surface is divided into separate compartments to carry two accessories 1216a and 1216b. Each modular accessory is substantially accommodated on the slide-away compartment 1204 within its (respective) compartment. It is also evident that the personal electronic device 34 is substantially accommodated within its compartment. The overall assembly thus has substantially flush surfaces at least when all of the compartments are in use. FIG. 12(e) shows that the docking station will hold the electronic device and any accessories proximate each other. This has the advantage that the overall impression to the user is that it is an integral piece of equipment.

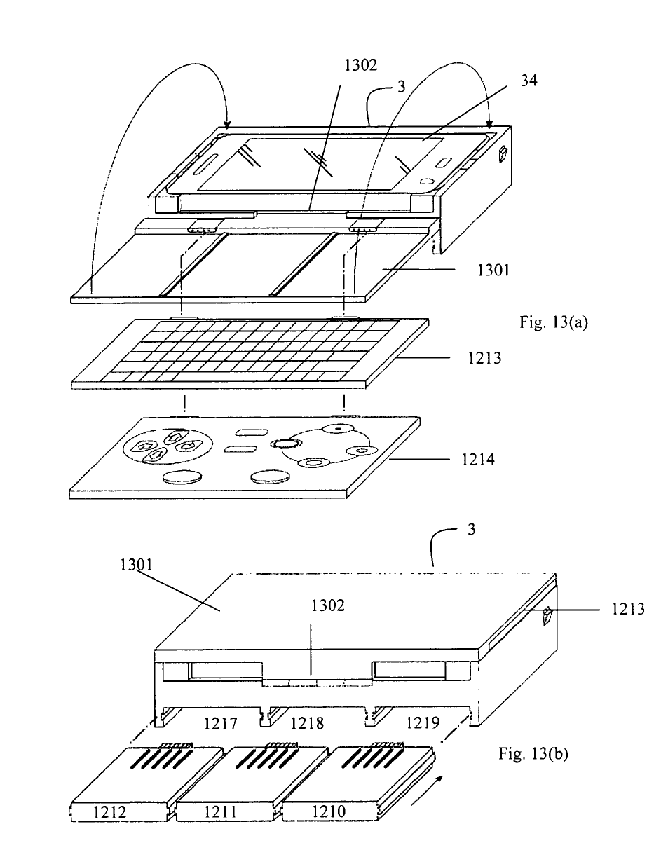

A pivotal arrangement is shown in FIG. 13(a) and (b) also where it is desired to have flip-over functionality, for example to bring a modular accessory from an underside to an upperside (or vice versa). FIG. 13(a) and FIG. 13(b) show an open and closed configuration of the docking station respectively. In FIG. 13(a) a supporting platform 1301 is employed as a lid/cover for the assembly. As shown in this embodiment the cover can be configured so that one or more of the personal electronic device or any accessory travels with the cover as it opens or closes. Alternatively the cover can be a simple pivoting cover without any personal electronic device or accessory arranged to travel with the opening or closing movement.

In this embodiment, the platform 1301 is further connected to the docking station 3 by means of a pivoting mechanism in the form of a hinge 1302 to form a cover for the personal electronic device 34. One side of the hinge is fixed to the sidewall 1304 of the docking station 3. To engage the platform as a cover, the platform 1301 pivots about the hinge 1302 as indicated by the arrow in FIG. 13(a). The hinge 1302 is best seen from FIG. 13(b) where it is seen between the platform 1301 and the sidewall 1304 of the docking station.

A variety of modular accessories such as tactile input devices for example a games controller or keyboard can be mounted on the supporting platform 1301 as shown in FIG. 13(a). In FIG. 13(b) the platform 1301 with a modular accessory 1213 attached also functions as a cover or lid, however the platform may be used as a cover with or without the accessory engaged. The cover 1301 provides a cover for the personal device once it is engaged in its compartment 1. In the configuration in FIG. 13(a) an open position of the docking support is achieved by pivoting the pivoting arrangement allows.

When the lid/platform is an open position such as illustrated in FIG. 13 (a) and the personal electronic device is engaged in its compartment 1 a combination of controllers and visual devices could result in the assembly having a layout similar to the layout of existing games consoles.

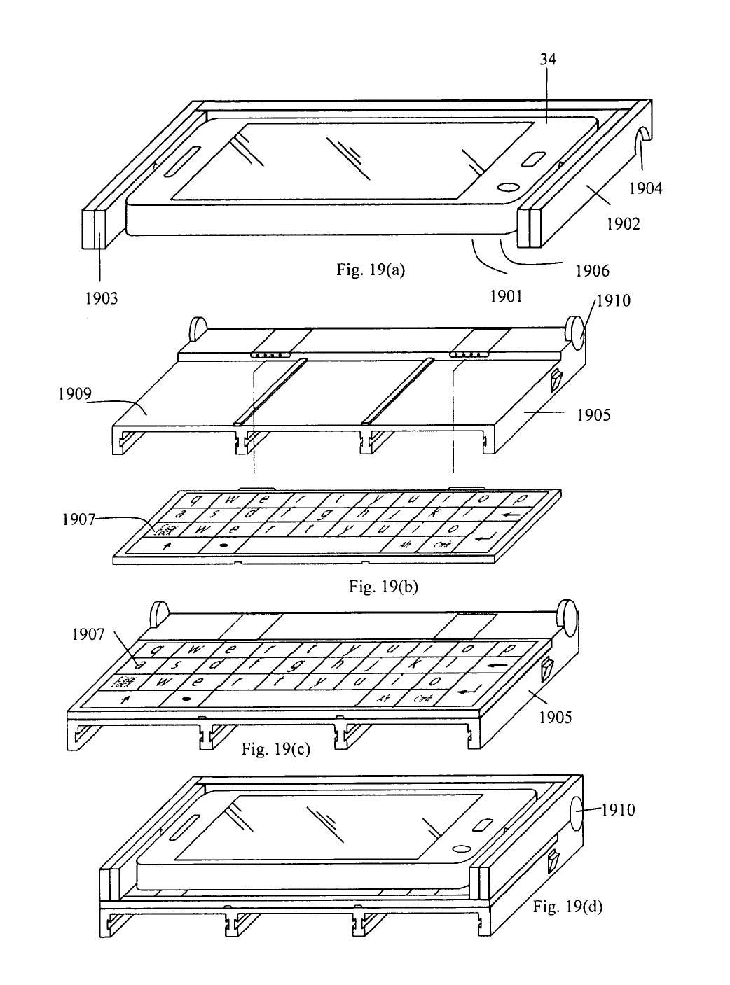

A further pivotal arrangement is shown in FIGS. 19(a)-(d). In this embodiment the personal electronic device is pivotably mounted with a first part of a docking support. The first part of the docking support connects to a second part of the docking support so that the two parts are pivotable relative to each other. FIG. 19(a) shows a first part 1901 of a docking support. The first part 1901 comprises a frame 1902. It will be noted that the frame 1902 is open on one side thereof. Such an open frame arrangement is useful in all embodiments of the invention. Within the (outer) frame 1902 is formed a pivot support in the form of an inner frame 1903. The inner frame 1903 is pivotably mounted in the outer frame as will be described in more detail below. A personal electronic device 34 is mounted in the inner frame 1903 and is thus pivotable relative to the outer frame 1902. There is thus a pivotal arrangement within the compartment space 1906 defined by the outer frame. A hinge recess 1904 is formed in the frame 1902 and is for hingedly connecting to a second part 1905 as shown in FIGS. 19(b) and 19(c).

In FIG. 19(b) a second part 1905 of a docking support is shown with an accessory 1907 (in the embodiment a miniature keyboard) aligned for insertion into a compartment 1909 as described for previous embodiments. FIG. 19(c) shows the accessory 1907 inserted into the compartment space 1909.

The two parts 1901, 1905 are arranged to form an assembly as shown in FIG. 19(d). In particular a hinge mechanism 1910 on the second part 1905 is arranged to engage with the first part in particular the hinge recess 1904 so that the two parts 1901, 1905 can pivot relative to each other. In particular it is desirable that the two parts are releasably engageable with each other. FIG. 19(d) shows a closed configuration with the personal electronic device arranged in a face-up arrangement. It will be appreciated that the assembled device has a compact configuration with substantially flush surfaces.

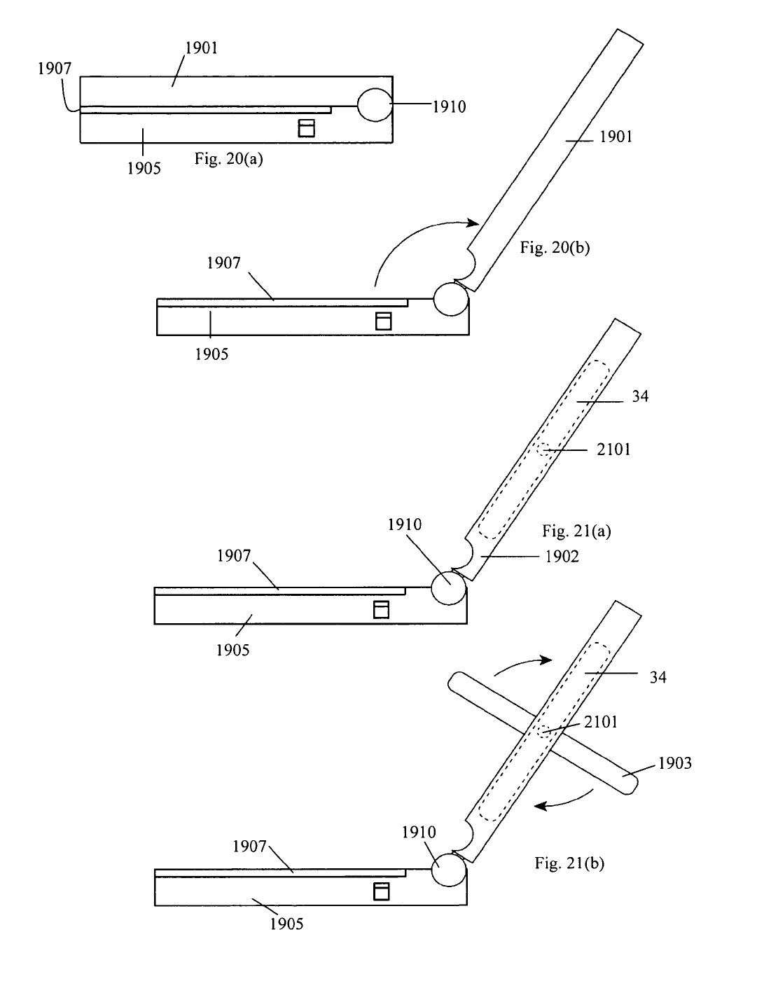

A side view of the closed configuration of FIG. 19(d) is shown in FIG. 20(a). FIG. 20 (b) shows (as indicated by the arrow) the opening of the device from the closed configuration to an open configuration. In the open configuration the first part 1901 forms a generally vertically orientated part while the second part forms a generally horizontally orientated part. In such an arrangement the generally horizontally held part is adapted to be held in the hand(s) of the user. It will be appreciated that in other configurations the personal device may be in the second part and the accessory therefore in the first part.

In an open configuration such as that shown in FIG. 20(b), the upper compartment space 1906 pivots about the hinge 1910 relative to the (supporting) part 1905. It will be appreciated that the upper compartment space can be held at any angle relative to the supporting part allowing the user to configure the docking support for their particular requirements.

It will be appreciated that this hinge mechanism also allows for flip-over functionality, for example to allow the upper compartment space to be employed as a lid/cover for the assembly.

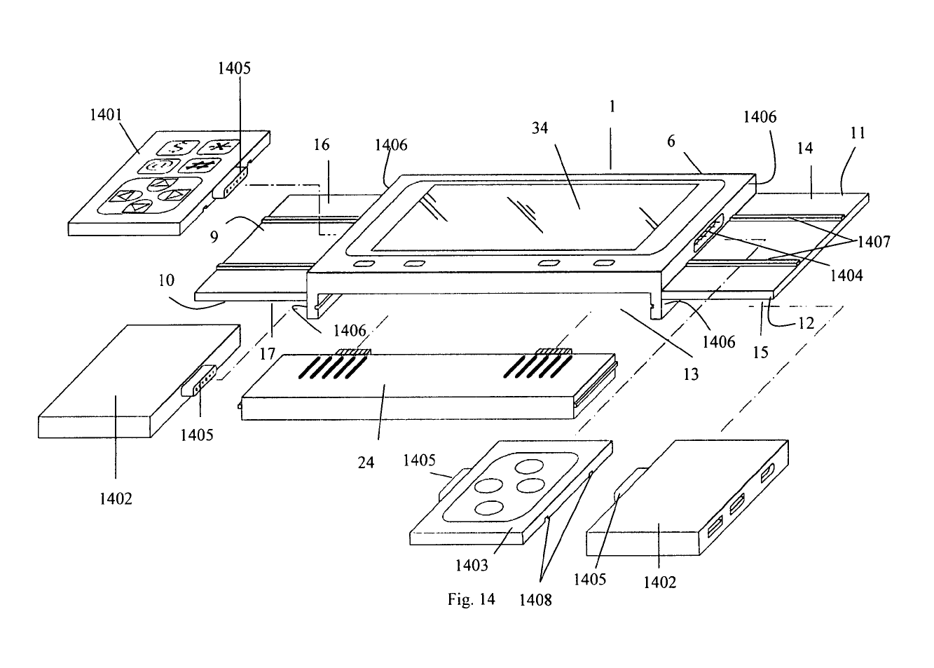

FIG. 14 illustrates an arrangement similar to that of FIG. 1, with an alternative engaging mechanism on compartments 9, 10, 11 and 12 in which a modular accessory for the personal electronic device is dockable. The compartment 1 containing the docked device 34 is defined by a docking support in the form of a frame or rim 6 having side walls of suitable material. The rim may have a removable sidewall that can be removed to facilitate the removal of the docked personal device. The sidewall 6 has apertures 1404 provided along the rim.

The connective arrangements shown in FIG. 14 are apertures or ports 1404 with connectors therein which (electronically) couple to connectors 1405 on the modular accessories. These connectors may be electronically connected to a terminal of the personal device when docked. Each of the connective arrangements are located within the frame 6 so that they are maintained internally within the docking station and are not visible once the accessory has been docked.

FIG. 14 shows additional compartments 9,10,11,12 and 13 in each of which a modular accessory for the personal electronic device is dockable. Each of the compartments is provided with a platform 14, 15, 16, and 17 that supports the modular accessory of the personal electronic device when docked. Sidewalls 1406 define the edges of each compartment. The dimensions of each of the compartments 9, 10, 11 and 12 are substantially equal. The embodiment shown in FIG. 14 illustrates additional compartments 9 and 11 which are provided on opposing sides of the first compartment 1 for the personal electronic device. Compartments 10 and 12 are on the under surface of the docking station and lie opposite compartments 9 and 11 respectively. Compartment 13 is on the under surface of the docking station and lies opposite the first compartment 1. Compartment 13 is arranged to receive a power source in the form of a battery pack 24 and in this embodiment the dimensions are larger than the compartments 9,10,11 or 12, which are arranged to receive smaller modular devices. The arrangement of compartments allows for modular devices to be arranged on either side of the personal electronic device.

A connective arrangement 1404 is provided in each additional compartment 9, 10, 11, 12 and 13. The connective arrangement shown in FIG. 14 is a port for receiving a plug 1405 on the modular device, however the connective arrangement may be a terminal, jack or wiring. The connective arrangement may further function as an anchoring means to anchor the modular accessory within the additional compartment. The connective arrangements 1405 are located within apertures in the sidewalls 1406 so that they are no longer visible within the compartment when the additional compartment is occupied. The modular accessories push fit into the port located at each additional compartment.

Each additional compartment 9, 10, 11, 12 and 13 is provided with a guiding means located on the platform 14, 15, 16, and 17. The guiding means can be used to guide the modular accessory to the correct position on the docking station 3. In FIG. 14 the guiding means is a rail 1407 which a modular device can engage. Once the modular device has engaged the rail by slotting a track 1408 located on the accessory on to the rail 1407, the module or device will be retained on the rail and can slide along the rail. The rail 1407 will guide the modular device so that the plug 1405 on the modular device is in a position to engage the port 1404 which may be a male or female connector.

FIG. 14 also shows the arrangement of the modular devices. Each modular device 1401, 1402, 1403 and 24 comprises a male or female (in the embodiment male) connective arrangement 1405 for engaging a corresponding female or male connective (in the embodiment female) arrangement 1404 at the relevant compartment of the docking station. Each modular device is provided with at least one track 1408 that is suitable for engaging the rails 1407 on each compartment of the docking station. It is clear from FIG. 14 that the additional compartment 13 is provided with two tracks as per the description of FIG. 1. Therefore the modular device 24 that is to be docked within additional compartment 13 is provided with two corresponding rails 28 and 29 on either side of the modular device 24 that can engage each of the tracks 19 on either side of the additional compartment 13. The dimensions of each of the modular devices are substantially equal to the dimensions of their corresponding compartments. Possible modular devices that could be positioned in the compartments are shown in FIG. 5. It will be appreciated that the sliding mechanism shown in FIG. 14 can be used in conjunction with any of the prior arrangements in landscape or portrait arrangements.

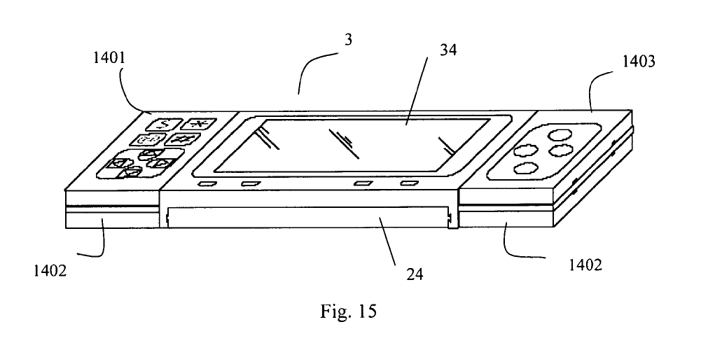

The modularity of the overall assembly is shown in FIG. 15. Each compartment within the docking station 3 is occupied. The dimensions of each of the modular devices 1401, 1402, 1403, 1404, 24 and the personal device 34 are such that a snug fit is achieved in which the edges of the modular devices are flush with the edges of the docking station 3. The assembly shown is, like that of all embodiments suitable for being hand-held.

FIG. 15 illustrates that the docking station will hold the electronic device and any accessories proximate to each other in such a way as to give an overall impression to the user that it is an integral piece of equipment.

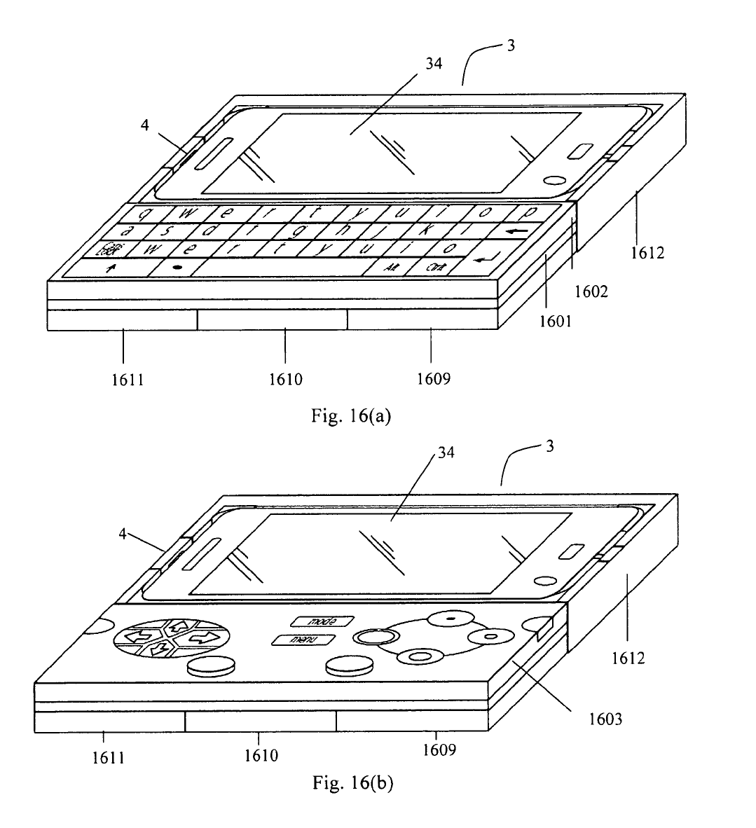

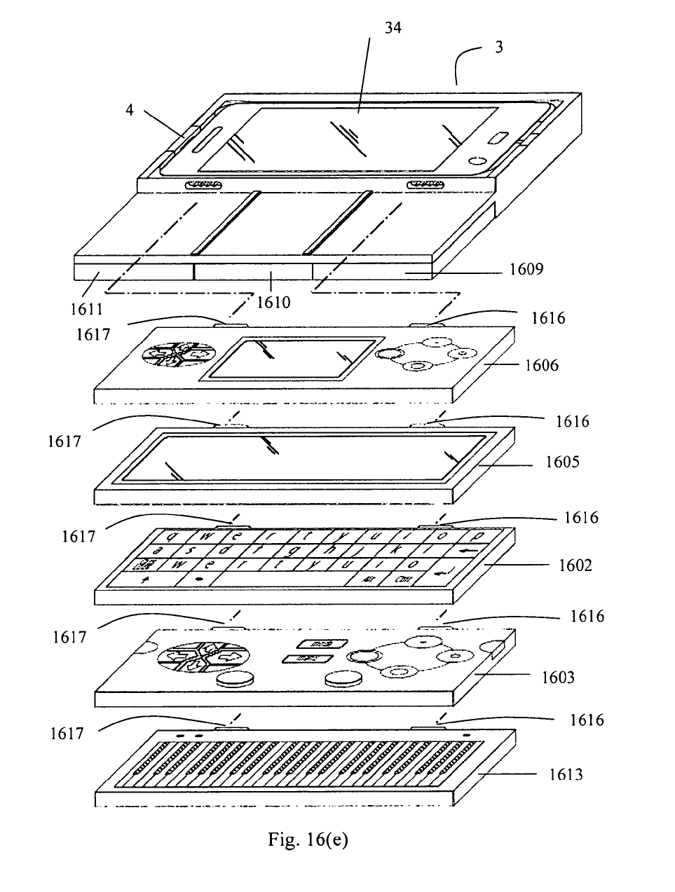

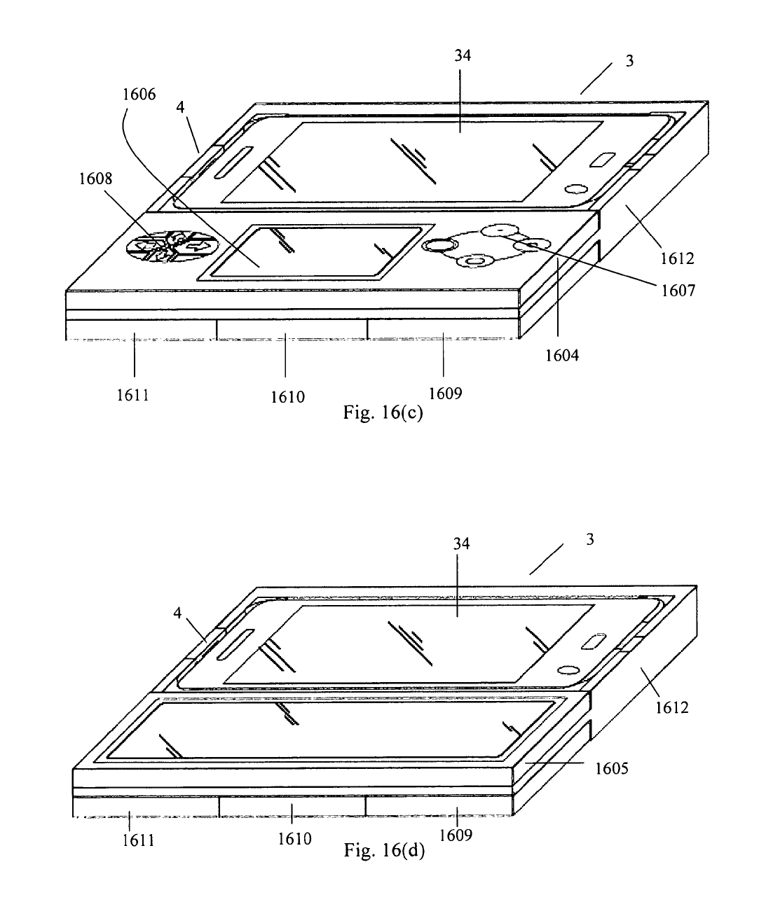

A planar longitudinal member 1601 in FIGS. 16 (a) to (e) forms a compartment space of the docking support. This member/platform is integrally moulded with the walls 1612 of the docking support. This platform 1601 provides rigid support for the accessories that are functionally connected to the personal electronic device 34 mounted in its compartment in the docking support. The accessories push fit to the docking station concealing the functional connectors within the docking support 3. These functional connectors 1614 and 1615 are clearly visible in FIG. 16(e). The accessories 1606, 1605, 1602, 1603 and 1613 have corresponding female or male connective (in the embodiment male) arrangements 1616 and 1617, which engage with the connectors 1614 and 1615. Once connected, the connections are concealed within the walls 1612 of the docking support as shown in FIGS. 16(a) to (d). The platform 1601 can supports the accessories once they have been docked within the compartment spaces

In FIG. 16(a) a Qwerty style keyboard occupies the full compartment space on the upper side of the platform 1601. The underside of the keyboard 1602 is supported by the platform. Three further accessories 1609, 1610 and 1611 are supported by the underside of the platform 1601. In FIG. 16(b), the keyboard 1602 is replaced by an alternative tactile input device, in this case, a games console 1603.

The tactile games console 1604 shown in FIG. 16(c) allows the docking support to be used in the style of the Nintendo DS where a small touch screen 1606 is bounded on either side by games controllers 1607 and 1608. Alternatively as shown in FIG. 16(d), a touch screen 1605 can also be employed. This touch screen is fully programmable and as such could be programmed by the user to function as a keyboard such as standard Qwerty arrangement or any preferred user character configuration such as Chinese, Japanese, Korean, or Cyrillic to interact with the personal electronic device.

Alternatively as in FIG. 16(e), the modular accessory can take the form of a piano style keyboard.

The accessories shown in FIG. 16 are entirely interchangeable within the compartment space and can equally be used with any of the configurations described in FIGS. 1 to 15.

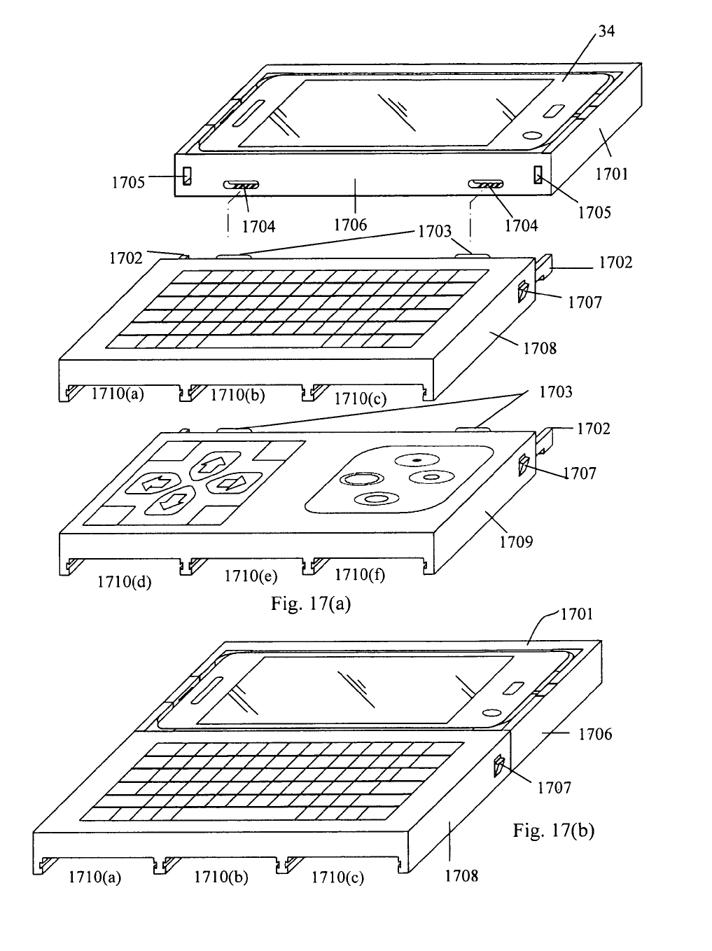

In a second aspect of the invention as shown in FIG. 17, a modular accessory of the invention can be both electrically and mechanically connected to a first compartment space 1701 in which the personal electronic device 34 is docked or housed. Apertures 1704 and 1705 in the wall 1706 of the first compartment space are available to engage the electrical 1703 and the mechanical connectors 1702 respectively.

One arrangement for mechanical inter-engagement between 1702 and 1704 is a push-fit inter-engagement such as a click-fit, snap-fit etc. A release mechanism is in the form of a releasable catch 1707 to allow removal of the accessory as required. In FIG. 17(a) two alternative accessories, a keyboard 1708 and a games controller 1709 are shown. Both of these modular accessories have defined therein further compartment spaces 1710a-c and 1710d-f respectively, in which further accessories are dockable. In FIG. 17 b the mechanical and electrical connections 1702 and 1703 are engageable with the apertures 1705 and 1704, and these connections are concealed within the walls 1706 of the first compartment space.

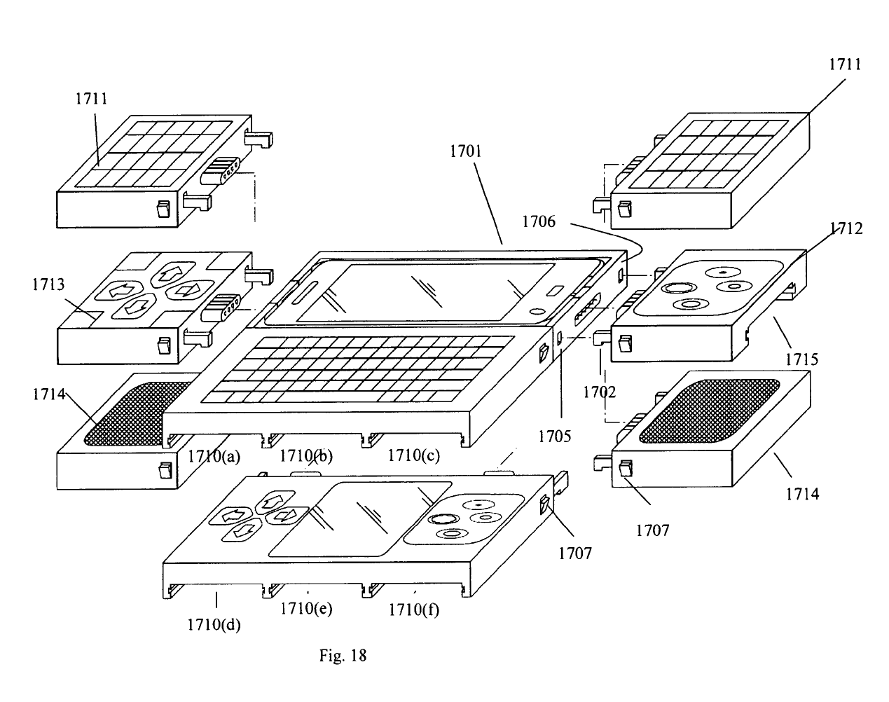

The mechanical and electrical connections may be positioned at any point with in the walls 1706. Modular accessories 1711, 1712, 1713, and 1714 are arranged to mechanically and electrically connect to the sidewalls of the first compartment space 1701 in a similar manner to the accessories 1708 and 1709. The modular accessory 1715 as shown in FIG. 18 has defined therein a second compartment space in which a further accessory is dockable. It will be appreciated that it is possible to have a plurality of compartment spaces defined in which further accessories are dockable.

FIG. 21(a) and FIG. 21(b) illustrate the additional functionality of the device. In particular FIG. 21(a) shows a view similar to FIG. 20(b) but additionally illustrates the potential further adjustability of the device. In the embodiment it is the personal electronic device, which is further adjustable, but as described above it may alternatively be one or more accessories.

FIG. 21(a) shows in dashed outline the inner frame 1903 in which the personal electronic device 34 can be arranged (as shown) in line with the first part 1901 and in particular frame 1902. It additionally shows a pivot connector 2101 that allows the orientations. The personal electronic device is electrically engaged with the docking support through the connector 2101.

FIG. 21(b) shows the possible rotation in a clockwise or anti-clockwise direction of the support frame about the pivot 2101. The support frame supports the personal electronic device as it rotates within its compartment space. The connector 2101 allows the personal electronic device to maintain functional connection with the docking support as it rotated through up to 360°. It will be appreciated that the personal electronic device can be held at any angle relative to its compartment space.

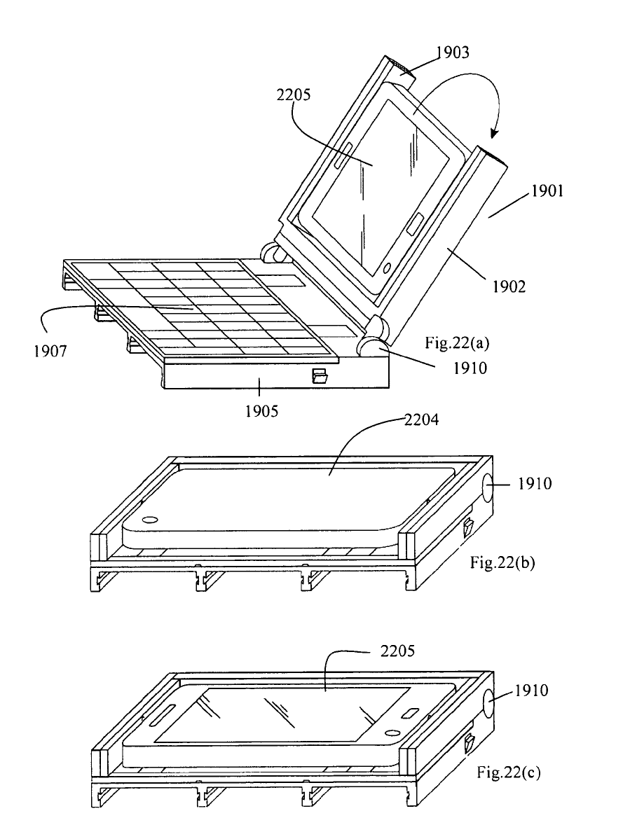

It will be appreciated that the personal electronic device can be flipped over to face up or face down configurations. In those configurations the docking support may be in an opened or closed configuration. FIG. 22(a) shows the open configuration of the device with the personal electronic device generally in the position shown in FIGS. 20(b) and 21(a).

The configuration shown in FIG. 22(a) is laptop type configuration. The screen side 2205 of the personal electronic device is orientated such that it is visible to the user using the accessory 1907 engaged on the second part 1905 of the docking support. The hinge mechanism 1910 allows the first part of the docking support 1901 be used as a lid for the arrangement. FIG. 22(b) and FIG. 22(c) show the closed/compact configuration of the device with the personal electronic device in respectively the face-down position and the face-up position. The face down configuration is useful for transport of the docking support as the screen side is face down and therefore protected. By pivoting the first part of the docking support 1901 about the hinge mechanism 1905, the assembly can go from the closed/compact arrangement shown in FIG. 22(b) to the open configuration shown in FIG. 22(a). By rotating the personal electronic device in the open configuration, through 180°, in either a clockwise or counter-clockwise direction, and then pivoting the first part of the docking configuration to a closed configuration the face up arrangements shown in FIG. 22(c) can be achieved.

In alternative embodiments the docking station may incorporate a motion sensor, which can be used in gaming wherein control of the game is done through physical motion of the docking station as opposed to through finger controls. Furthermore the docking station may have WIFI capabilities allowing wireless connection to the Internet, wireless peer-to-peer connectivity or allowing connection to phone landlines.

It will be appreciated that additional wireless connections may be incorporated to allow the user to interact with an additional interface unit such as a TV screen.

In one embodiment of the present invention the processing of data may be carried out by the personal electronic device controlled by one or more modular accessories and the output displayed on an external interface unit such as a TV screen or monitor.

Another embodiment includes a docking station comprising two SIM cards allowing connection to at least two networks. A further embodiment includes a docking station comprising an external CPU which allows improved performance of the personal electronic device. Furthermore the docking station may incorporate an additional hard disk drive, hybrid drive, solid state drive or the like which can be used in conjunction with the personal electronic device to further increase performance.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1-49. (canceled)

50. A hand-held docking station kit for a personal electronic device such as a mobile phone, the docking station kit comprising:
a docking support having defined therein:
a first compartment space in which the personal electronic device is dockable;
a second compartment space in which a modular accessory for the personal electronic device is dockable; and
at least two modular accessories which are interchangeably dockable within the second compartment space.

51. The docking station kit as claimed in claim 50 wherein the docking support comprises three or more compartments.

52. The docking station kit as claimed in claim 50 wherein the modular accessories are input or output devices that can be used to output from the personal electronic device or to input to the personal electronic device.

53. The docking station kit as claimed in claim 50 wherein the docking support further comprises a third compartment in which a modular accessory for the personal electronic device is dockable.

54. The docking station kit as claimed in claim 53 wherein the second and third compartments are on opposing sides of the first compartment space for the personal electronic device or
the second and third compartments are on the same side of the first compartment space for the personal electronic device or
the second and third compartments are below the first compartment space for the personal electronic device.

55. The docking station kit as claimed in claim 50 further comprising a pivot arrangement for allowing mating of the personal electronic device or accessory with the docking support.

56. The docking station kit as claimed in claim 50 further comprising a pivotable arrangement for one or more of the personal electronic device and any accessory while functionally connected to the docking support.

57. The docking station kit of claim 56 wherein the docking support comprises at least two docking support portions which are connected by a pivot arrangement which allows the docking support portions to pivot relative to each other.

58. The docking station kit as claimed in claim 57 wherein the pivot arrangement is provided to allow open and closed configurations of the docking support.

59. The docking station kit as claimed in claim 56 comprising a cover and being configured so that one or more of the personal electronic device or any accessory travels with the cover as it opens or closes.

60. The docking station kit as claimed in claim 57 wherein the pivot arrangement is provided to allow flip-over functionality.

61. The docking station kit as claimed claim 51 further comprising a pivotable support frame within one or more compartment spaces so that one or more of the personal electronic device or any accessory can pivot relative to the compartment space while functionally connected to the docking support.

62. The docking station kit as claimed claim 50 further comprising a sliding mechanism to allow one or more compartments for an accessory to slide relative to the compartment for the personal electronic device.

63. The docking station kit as claimed in claim 50 wherein the docking station kit is adapted to be dockable within a further docking station.

64. A docking station kit according to claim 52 wherein said at least one accessory is a tactile input device.

65. A hand-held docking support having defined therein:
a first compartment space in which a personal electronic device is dockable; and
a second compartment space in which a modular accessory for the personal electronic device is dockable.

66. A modular accessory adapted to mate to a docking support according to claim 65.

67. A modular accessory according to claim 66 the accessory having defined therein:
a first compartment space in which a further accessory is dockable.

68. A modular accessory according to claim 67 wherein the accessory has defined therein a second compartment space in which a further accessory is dockable.

69. A modular accessory according to claim 68 wherein the or each further accessory is modular.
